(19) United States
(12) Patent Application Publication
(10) Pub. No.: US 2017/0066989 A1
(43) Pub. Date: Mar. 9, 2017

(54) IONIC LIQUID, LUBRICANT, AND MAGNETIC RECORDING MEDIUM

(71) Applicant: DEXERIALS CORPORATION, Shinagawa-ku, Tokyo (JP)

(72) Inventors: Hirofumi KONDO, Tokyo (JP); Kouki HATSUDA, Tokyo (JP); Makiya ITO, Tokyo (JP); Nobuo TANO, Tokyo (JP); Kyungsung YUN, Tokyo (JP); Masayoshi WATANABE, Kanagawa (JP)

(73) Assignee: DEXERIALS CORPORATION, Shinagawa-ku, Tokyo (JP)

(21) Appl. No.: 15/308,450

(22) PCT Filed: Apr. 28, 2015
(86) PCT No.: PCT/JP2015/062832

§ 371 Date: Nov. 2, 2016

(30) Foreign Application Priority Data
May 29, 2014 (JP) 2014-111221

(51) Int. Cl. C10M 105/72; G11B 5/725; C10M 135/10; C10M 105/70; C10M 105/60

(52) U.S. Cl. CPC C10M 105/72; C10M 105/70; C10M 105/60; C10M 135/10; G11B 5/725; C10N 2220/04; C10M 2215/04; C10M 2215/221; C10N 2240/204; C10M 2219/04

(57) ABSTRACT

A lubricant including an ionic liquid, which contains a conjugate acid (B⁺) and a conjugate base (X⁻) and is aprotic, wherein the conjugate acid contains a straight-chain hydrocarbon group having 10 or more carbon atoms, and wherein an acid that is a source of the conjugate base has a pKa in water of 0 or less.

### TECHNICAL FIELD

The present invention relates to an aprotic ionic liquid, a lubricant containing the ionic liquid, and a magnetic recording medium using the lubricant.

### BACKGROUND ART

Conventionally, in a thin film magnetic recording medium, a lubricant is applied onto a surface of a magnetic layer for the purpose of reducing frictions between a magnetic head and the surface of the magnetic recording medium, or reducing abrasion. In order to avoid adhesion, such as sticktion, an actual film thickness of the lubricant is of a molecular order. Accordingly, it is not exaggeration to say that the most important thing for a thin film magnetic recording medium is to select a lubricant having excellent abrasion resistance in any environment.

During a life of a magnetic recording medium, it is important that a lubricant is present on a surface of the medium without causing desorption, spin-off, and chemical deteriorations. Making the lubricant present on a surface of a medium is more difficult, as the surface of the thin film magnetic recording medium is smoother. This is because the thin film magnetic recording medium does not have an ability of replenishing a lubricant as with a coating-type magnetic recording medium.

In the case where an adhesion force between a lubricant and a protective film disposed at a surface of a magnetic layer is weak, moreover, a film thickness of the lubricant is reduced during heating or sliding hence accelerating abrasion. Therefore, a large amount of the lubricant is required. The large amount of the lubricant is the mobile lubricant, and therefore a function of replenishing the lost lubricant can be provided. However, an excessive amount of the lubricant makes the film thickness of the lubricant larger than the surface roughness. Therefore, a problem associated with adhesion is caused, and in a crucial case, sticktion is caused, which is a factor of driving failures. These problems associated with frictions have not been sufficiently solved by conventional perfluoropolyether (PFPE)-based lubricants.

Particularly for a thin film magnetic recording medium having high surface smoothness, a novel lubricant is designed at a molecular level, and synthesized to solve the above-described trade-off. Moreover, there are numbers of reports regarding lubricity of PFPE. As described, lubricants are very important in magnetic recording media.

Chemical structures of typical PFPE-based lubricants are depicted in Table 1.

TABLE 1
Fomblin-based lubricants

| | |
|---|---|
| | X—CF₂(OCF₂CF₂)ₙ(OCF₂)ₘOCF₂—X(0.5 < n/m < 1) |
| Z | X═—OCF₃ |
| Z—DOL | X═—CH₂OH |
| Z—DIAC | X═—COOH |
| Z—Tetraol | X═—CH₂OHOCH₂CHCH₂OH |
| AM2001 | 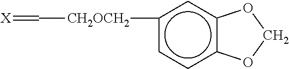 |

Other lubricants

| | |
|---|---|
| A20H | 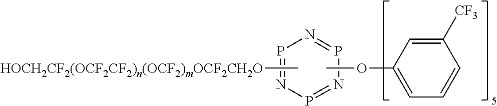 |
| Mono | F—(CF₂CF₂CF₂O)₁—CF₂CF₂CH₂—N(C₃H₇)₂ |

Z-DOL in Table 1 is one of lubricants typically used for thin-film magnetic recording media. Moreover, Z-Tetraol (ZTMD) is a lubricant, in which a functional hydroxyl group is further introduced into a main chain of PFPE, and it has been reported that use of Z-Tetraol enhances reliability of a drive while reducing a space at an interface between a head and a medium. It has been reported that A20H suppresses decomposition of the PFPE main chain with Lewis acid or Lewis base, and improves tribological properties. On the other hand, it has been reported that Mono has a different polymer main chain and different polar groups to those of the PFPE, and the polymer main chain and polar groups of Mono are respectively poly-n-propyloxy, and amine, and Mono reduces adhesion interactions at near contact.

However, a typical solid lubricant, which has a high melting point and is considered thermally stable, disturbs an electromagnetic conversion process that is extremely highly sensitive, and moreover, an abrasion powder scraped by a head is generated on a running track. Therefore, abrasion properties are deteriorated. As described above, the liquid lubricant has mobility that enables to move the adjacent lubricant layer to replenish the lubricant removed due to abrasion by the head. However, the lubricant is span-off from a surface of the disk especially at a high temperature during driving of the disk, because of the mobility of the lubricant, and thus the lubricant is reduced. As a result, a protection function is lost. Accordingly, a lubricant having a high viscosity and low volatility is suitably used, and use of such a lubricant enables to prolong a service life of a disk drive with suppressing an evaporation rate.

Considering the above-described lubricating systems, requirements for a low-friction and low-abrasion lubricant used for thin film magnetic recording media are as follows.

(1) Low volatility.
(2) Low surface tension for a surface filling function.
(3) Interaction between terminal polar groups and a surface of a disk.
(4) High thermal and oxidization stability in order to avoid decomposition or reduction over a service period.
(5) Chemically inactive with metals, glass, and polymers, and no abrasion powder generated from a head or a guide.
(6) No toxicity and no flammability.
(7) Excellent boundary lubricating properties.
(8) Soluble with organic solvents.

Recently, an ionic liquid has been attracted attentions as one of solvents for synthesis of organic or inorganic materials and being friendly to the environments in the fields of electricity storage materials, a separation technology, and a catalyst technology. The ionic liquid is roughly classified as a molten salt having a low melting point. The ionic liquid is typically a molten salt having a melting point of 100° C. or lower, among the above-mentioned molten salts. The important properties of the ionic liquid used as a lubricant are low volatility, inflammability, thermal stability, and an excellent dissolving performance. Accordingly, because of the characteristics of the ionic liquid, the ionic liquid is expected to be applicable as a novel lubricant used in an extreme environment, such as in vacuum, and high temperature. Moreover, known is a technique where a controllability of a transistor is enhanced 100 times a controllability of a conventional transistor by using an ionic liquid in a gate of a single self-assembled quantum dot transistor. In this technique, the ionic liquid forms an electric double layer, which functions as an insulating film of about 1 nm, to thereby obtain a large capacitance.

For example, abrasion and wear of a surface of a metal or ceramic may be reduced by using a certain ionic liquid compared to a conventional hydrocarbon-based lubricant. For example, there is a report that, in the case where an imidazole cation-based ionic liquid is synthesized by substituting with a fluoroalkyl group, and tetrafluoroboric acid salt or hexafluorophosphoric acid salt of alkyl imidazolium is used for steel, aluminium, copper, single crystal SiO₂, silicon, or sialon ceramics (Si—Al—O—N), tribological properties more excellent than those of cyclic phosphazene (X-1P) or PFPE are exhibited. Moreover, there is a report that an ammonium-based ionic liquid reduces frictions more than a base oil in the region of elastohydrodynamic to boundary lubrication. Moreover, effects of the ionic liquid as an additive for a base oil have been studied, and a chemical or tribochemical reaction of the ionic liquid has been researched to understand lubricating systems. However, there are almost no application examples of the ionic liquid to magnetic recording media.

Meanwhile, a protic ionic liquid (PIL) is a collective name of a compound formed by a chemical reaction between Bronsted acid and an equivalent amount of Bronsted base. It has been reported that perfluorooctanoic acid alkyl ammonium salt is PIL, and has a significant effect of reducing frictions of a magnetic recording medium compared with the above-mentioned Z-DOL (see PTL 1 and PTL 2, and NPL 1 to NPL 3).

Reported is a lubricant for a magnetic recording medium where thermal stability of the lubricant is enhanced by making a difference (ΔpKa) between pKa of acid and pKa of base large using sulfonic acid ammonium salt (see NPL 4). In this report, it has been confirmed that a mechanism of thermal stability of the lubricant is different depending on a value of ΔpKa, and a weight loss is endothermic and the weight loss occurs due to evaporation in the case where a value of ΔpKa as measured by DG/DTA is small, whereas a weight loss is exothermic and the weight loss is dominantly caused by thermal decomposition in the case where a value of ΔpKa is large.

Meanwhile, the limit of a surface recording density of a hard disk is said to be from 1 Tb/in² to 2.5 Tb/in². Currently, a surface recording density of a hard disk is getting closer to the limit, but developments of techniques for large capacities of recording media have been actively performed with reduction in a size of magnetic particles as a premise. As a technique for a large capacity of a recording medium, there are techniques, such as reduction in an effective flying height, and introduction of Single Write (BMP).

As a recording technique of the next generation, moreover, there is “heat assisted magnetic recording.” FIG. 3 illustrates a schematic view of heat-assisted magnetic recording. In FIG. 3, reference numeral 1 is laser light, reference numeral 2 is near-field light, reference numeral 3 is a recording head (PMR element), and reference numeral 4 is a reproducing head (TMR element). Examples of a problem of this technique include a deterioration of durability due to evaporation or decomposition of a lubricant present on a surface of a magnetic layer, because a recording area is heated with laser at the time of recording and reproducing. In heat-assisted magnetic recording, a recording medium may be exposed to a high temperature, such as 400° C. or higher, even though it is for a short period. Therefore, thermal stability of a lubricant is concerned, if the lubricant is a typically used lubricant Z-DOL for thin film magnetic recording media, or a carboxylic acid ammonium salt-based lubricant.

### CITATION LIST

### Patent Literature

PTL 1: Japanese Patent (JP-B) No. 2581090
PTL 2: JP-B No. 2629725

### Non Patent Literature

NPL 1: Kondo, H., Seto, J., Haga. S., Ozawa, K., (1989) Novel Lubricants for Magnetic Thin Film Media, Magnetic Soc. Japan, Vol. 13, Suppl. No. 51, pp. 213-218
NPL 2: Kondo, H., Seki, A., Watanabe, H., & Seto, J., (1990). Frictional Properties of Novel Lubricants for Magnetic Thin Film Media, IEEE Trans. Magn. Vol. 26, No. 5, (September 1990), pp. 2691-2693, ISSN: 0018-9464
NPL 3: Kondo, H., Seki, A., & Kita, A., (1994a). Comparison of an Amide and Amine Salt as Friction Modifiers for a Magnetic Thin Film Medium. Tribology Trans. Vol. 37, No. 1, (January 1994), pp. 99-105, ISSN: 0569-8197
NPL 4: Hirofumi Kondo, Makiya Ito, Kouki Hatsuda, Kyungsung Yun, Masayoshi Watanabe, New ionic liquid lubricants for magnetic thin film media IEEE Trans. Magn., 2013, Vol. 49, issue 7, pp. 3756-3759

### SUMMARY OF INVENTION

### Technical Problem

The present invention aims to solve the above-described various problems in the conventional art, and achieve the following object. Specifically, the present invention has an object to provide an ionic liquid having excellent lubricity even at a high temperature, a lubricant having excellent lubricity even at a high temperature, and a magnetic recording medium having excellent practical properties even at a high temperature.

### Solution to Problem

Means for solving the above-described problems are as follows:

<1> A lubricant including:
an ionic liquid, which contains a conjugate acid (B⁺) and a conjugate base (X⁻), and is aprotic,
wherein the conjugate acid contains a straight-chain hydrocarbon group having 10 or more carbon atoms, and
wherein an acid that is a source of the conjugate base has a pKa in water of 0 or less.
<2> The lubricant according to <1>,
wherein the conjugate acid is generated from a base containing a straight-chain hydrocarbon group having 10 or more carbon atoms, and the base is amine, amidine, guanidine, or imidazole.
<3> The lubricant according to <1> or <2>,
wherein the ionic liquid is represented by one of the following general formulae (1) to (3):

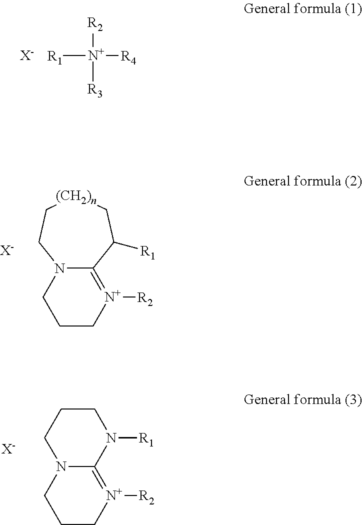

where R₁, R₂, R₃, and R₄ are groups other than hydrogen atoms, and at least one of R₁, R₂, R₃, and R₄ is a group containing a straight-chain hydrocarbon group having 10 or more carbon atoms in the general formula (1),
where R₁ is a group containing a straight-chain hydrocarbon group having 10 or more carbon atoms, R₂ is a group other than a hydrogen atom, and n is 0 or 1 in the general formula (2), and
where R₁ is a group containing a straight-chain hydrocarbon group having 10 or more carbon atoms, and R₂ is a group other than a hydrogen atom in the general formula (3).
<4> The lubricant according to any one of <1> to <3>,
wherein the conjugate base is represented by the following general formula (4):

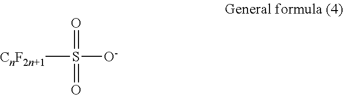

where n is an integer of 0 or greater in the general formula (4).
<5> The lubricant according to any one of <1> to <3>,
wherein the conjugate base is represented by one of the following structural formulae (1) to (4):

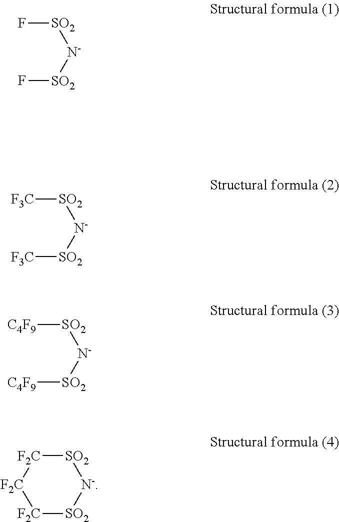

<6> The lubricant according to any one of <1> to <3>,
wherein the conjugate base is represented by the following general formula (5):

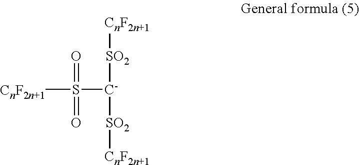

where n is an integer of 1 or greater in the general formula (5).
<7> The lubricant according to any one of <1> to <6>,
wherein the hydrocarbon group is an alkyl group.
<8> A magnetic recording medium including:
a non-magnetic support;
a magnetic layer on the non-magnetic support; and
the lubricant according to any one of <1> to <7> on the magnetic layer.
<9> An ionic liquid including:
a conjugate acid (B⁺); and
a conjugate base (X⁻),
wherein the conjugate acid contains a straight-chain hydrocarbon group having 10 or more carbon atoms,
wherein an acid that is a source of the conjugate base has a pKa in water of 0 or less, and
wherein the ionic liquid is aprotic.
<10> The ionic liquid according to <9>,
wherein the conjugate acid is generated from a base containing a straight-chain hydrocarbon group having 10 or more carbon atoms, and the base is amine, amidine, guanidine, or imidazole.
<11> The ionic liquid according to <9> or <10>,
wherein the ionic liquid is represented by one of the following general formulae (1) to (3):

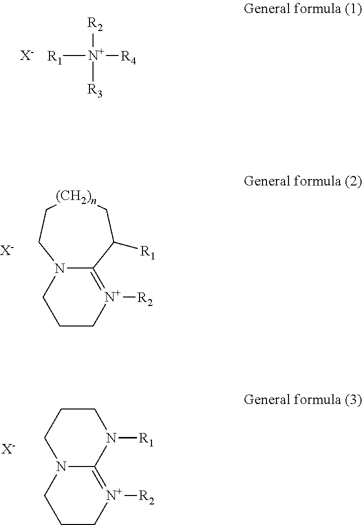

where R₁, R₂, R₃, and R₄ are groups other than hydrogen atoms, and at least one of R₁, R₂, R₃, and R₄ is a group containing a straight-chain hydrocarbon group having 10 or more carbon atoms in the general formula (1),
where R₁ is a group containing a straight-chain hydrocarbon group having 10 or more carbon atoms, R₂ is a group other than a hydrogen atom, and n is 0 or 1 in the general formula (2), and
where R₁ is a group containing a straight-chain hydrocarbon group having 10 or more carbon atoms, and R₂ is a group other than a hydrogen atom in the general formula (3).
<12> The ionic liquid according to any one of <9> to <11>,
wherein the conjugate base is represented by the following general formula (4):

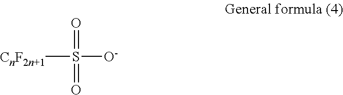

where n is an integer of 0 or greater in the general formula (4).
<13> The ionic liquid according to any one of <9> to <11>,
wherein the conjugate base is represented by one of the following structural formulae (1) to (4):

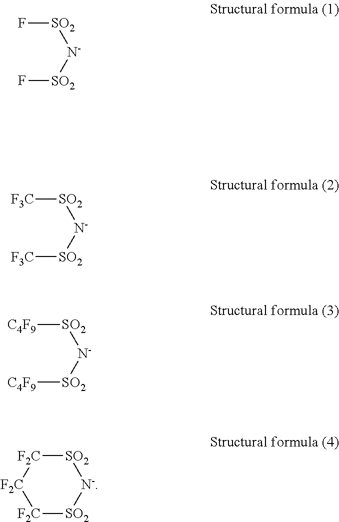

<14> The ionic liquid according to any one of <9> to <11>,
wherein the conjugate base is represented by the following general formula (5):

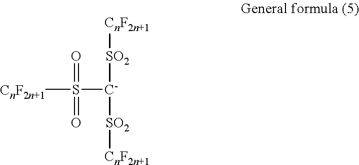

where n is an integer of 1 or greater in the general formula (5).
<15> The ionic liquid according to any one of <9> to <14>, wherein the hydrocarbon group is an alkyl group.

### Advantageous Effects of the Invention

The present invention can solve the above-described various problems in the conventional art, and can provide an ionic liquid having excellent lubricity even at a high temperature, a lubricant having excellent lubricity even at a high temperature, and a magnetic recording medium having excellent practical properties even at a high temperature.

### BRIEF DESCRIPTION OF DRAWINGS

FIG. 1 is a cross-sectional view illustrating one example of a hard disk according to one embodiment of the present invention.

FIG. 2 is a cross-sectional view illustrating one example of a magnetic tape according one embodiment of the present invention.

FIG. 3 is a schematic view illustrating heat-assisted magnetic recording.

FIG. 4 is the TG/DTA measurement result of the product of Example 1.

FIG. 5 is the FTIR spectrum of the product of Example 1.

FIG. 6 is the TG/DTA measurement of the product of Example 2.

FIG. 7 is the FTIR spectrum of the product of Example 2.

FIG. 8 is the TG/DTA measurement of the product of Example 3.

FIG. 9 is the FTIR spectrum of the product of Example 3.

FIG. 10 is the TG/DTA measurement of the product of Example 4.

FIG. 11 is the FTIR spectrum of the product of Example 4.

FIG. 12 is the FTIR spectrum of the product of Comparative Example 2.

FIG. 13 is the FTIR spectrum of the product of Comparative Example 3.

FIG. 14 is the TG/DTA measurement of the product of Comparative Example 3.

FIG. 15 is the FTIR spectrum of the product of Comparative Example 4.

### DESCRIPTION OF EMBODIMENTS

### (Lubricant and Ionic Liquid)

A lubricant of the present invention includes the ionic liquid of the present invention, and may further include other components according to the necessity.

The ionic liquid of the present invention includes a conjugate acid (B⁺) and a conjugate base (X⁻).

The conjugate acid contains a straight-chain hydrocarbon group having 10 or more carbon atom.

An acid that is a source of the conjugate base has a pKa in water of 0 or less.

The ionic liquid is aprotic.

The present inventors have found that thermal stability of an aprotic ionic liquid (AIL) is higher than a protic ionic liquid thermal stability of which depends on equilibrium of acid and base, and have accomplished the present invention based on the findings above.

The ionic liquid can exhibit excellent thermal stability because the pKa of an acid that is a source of the conjugate base is 0 or less.

In the present specification, the pKa is an acid dissociation constant, and is an acid dissociation constant in water.

For example, the acid dissociation constant in water can measured with reference to a method disclosed in J. Chem. Res., Synop. 1994, 212-213. Specifically, the acid dissociation constant in water can be measured by a combination of a spectrometer and a potential difference measurement.

The ionic liquid being aprotic means that the ionic liquid does not have a proton donor ability. For example, the ionic liquid being aprotic means a state where active protons are not bonded to cationic atoms of the conjugate acid (B⁺) in the ionic liquid.

### <Conjugate Acid>

The conjugate acid (B⁺) contains a straight-chain hydrocarbon group having 10 or more carbon atoms.

The upper limit of the number of carbon atoms of the straight-chain hydrocarbon group having 10 or more carbon atoms is not particularly limited, and can be appropriately selected depending on the intended purpose. The number of carbon atoms is preferably 25 or less, and more preferably 20 or less in view of readily availability of raw materials. Since the hydrocarbon group has a long chain, a coefficient of friction can be reduced, and lubricity is therefore improved.

As long as the hydrocarbon group is in the form of a straight chain, the hydrocarbon group may be a saturated hydrocarbon group, or an unsaturated hydrocarbon group containing double bonds at a part, or an unsaturated branched hydrocarbon group partially containing a branched structure. Among them, the hydrocarbon group is preferably an alkyl group, which is a saturated hydrocarbon group, in view of abrasion resistance. Moreover, the hydrocarbon group is also preferably a straight-chain hydrocarbon group that does not have any branch even partially.

The conjugate acid is preferably generated from a base containing a straight-chain hydrocarbon group having 10 or more carbon atoms.

The pKa of the base in water is not particularly limited, but preferably 9 or greater.

As the base, for example, used is a base that is to be a conjugate acid containing positively charged nitrogen, when an ion pair is formed with a conjugate acid and a conjugate base. Examples of such a base include amines, hydroxyl amines, imines, oximes, hydrazines, hydrazones, guanidines, amidines, sulfoamides, imides, amides, thioamides, carbamates, nitriles, ureas, urethanes, and heterocycles. Examples of the heterocycles include pyrrole, indole, azole, oxazole, triazole, tetraazole, and imidazole. Examples of the amines include aliphatic amine, aromatic amine, cyclic amine, amidine, and guanidine. Examples of the aliphatic amine include tertiary aliphatic amine. Examples of the aromatic amine include dimethylaniline, triphenyl amine, and a 4-dimethylaminopyridine derivative. Examples of the cyclic amine include pyrrolidine, 2,2,6,6-tetramethylpiperidine, and a quinuclidine derivative. Examples of the amidine and the guanidine include cyclic amidine, and cyclic guanidine. Specifically, strong base compounds presented in Table 1 can be used, but a structure of the base is not limited to the compounds of Table 1.

Among the above-listed examples, amine, amidine, guanidine, and imidazole are preferable.

In the present specification, “the base that is a source” means a base used for forming a conjugate acid. Among bases formed from conjugate acid, “the base that is a source” is preferably a base having large pKa. For example, the base is preferably amine having large pKa among amines generated by the following formula.

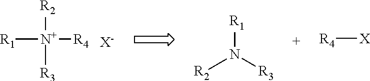

Examples of the conjugate acid include conjugate acids represented by the following general formula (1-1), conjugate acids represented by the following general formula (2-1), and conjugate acids represented by the following general formula (3-1).

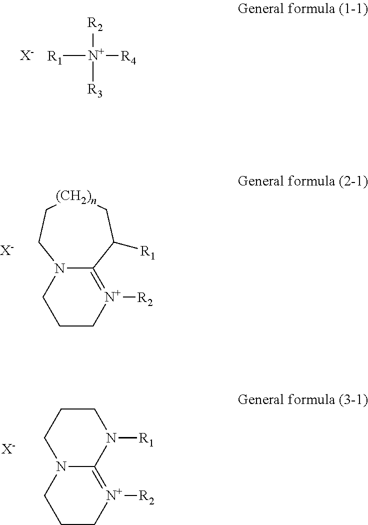

In the general formula (1-1), R₁, R₂, R₃, and R₄ are groups other than hydrogen atoms, and at least one of R₁, R₂, R₃, and R₄ is a group containing a straight-chain hydrocarbon group having 10 or more carbon atoms.

In the general formula (2-1), R₁ is a group containing a straight-chain hydrocarbon group having 10 or more carbon atoms, R₂ is a group other than a hydrogen atom, and n is 0 or 1.

In the general formula (3-1), R₁ is a group containing a straight-chain hydrocarbon group having 10 or more carbon atoms, and R₂ is a group other than a hydrogen atom.

Note that, the conjugate acids in the general formulae (2-1) and (3-1) may have other resonance structures (canonical structures). Specifically, the conjugate acids can have resonance structures (canonical structures), in which another nitrogen atom is positively charged, and R₂ is bonded to the nitrogen atom. In the present invention, a conjugate acid having such a resonance structure (a canonical structure) is also included in the conjugate acid represented by the general formula (2-1) and the conjugate acid represented by the general formula (3-1).

Examples of the group other than a hydrogen atom as R₁, R₂, R₃, and R₄ in the general formula (1-1) include an aryl group, a cycloalkyl group, and an alkyl group. Examples of the alkyl group include an alkyl group having from 1 to 20 carbon atoms. Among R₁, R₂, R₃, and R₄, a group other than the group containing a straight-chain hydrocarbon group having 10 or greater carbon atoms is preferably an alkyl group having from 1 to 6 carbon atoms.

Examples of R₂ in the general formulae (2-1) and (3-1) include an alkyl group. The alkyl group is preferably an alkyl group having from 1 to 20 carbon atoms, and more preferably an alkyl group having from 1 to 6 carbon atoms.

Examples of the conjugate acid represented by the general formula (1-1) include trimethylalkyl ammonium (except that the alkyl is an alkyl having 10 or more carbon atoms). Examples of the trimethylalkyl ammonium include trimethyloctadecyl ammonium [C₁₈H₃₇N⁺(CH₃)₃], trimethyldecyl ammonium [C₁₀H₂₁N⁺(CH₃)₃], trimethyltetradecyl ammonium [C₁₄H₂₉N⁺(CH₃)₃], trimethyleicosyl ammonium [C₂₀H₄₁N⁺(CH₃)₃], trimethyloleyl ammonium [C₁₈H₃₅N⁺(CH₃)₃], and trimethyl-2-heptylundecyl ammonium [CH₃(CH₂)₈CH(C₇H₁₅)CH₂N⁺(CH₃)₃].

It is however needless to say that the structure of the conjugate acid represented by the general formula (1-1) is not limited to the above-listed examples. For example, a group derived from a heterocyclic compound, an alicyclic compound, or an aromatic compound may be introduced into at least one of R₁, R₂, R₃, and R₄.

A base that is a source of the conjugate acid can be synthesized, for example, from a base derivative disclosed in non-patent literature (Ivari Kaljurand, Agnes Kütt, Lilli Sooväli, Toomas Rodima, Vahur Mäemets, Ivo Leito,* and Ilmar A. Koppel,” Extension of the Self-Consistent Spectrophotometric Basicity Scale in Acetonitrile to a Full Span of 28 pKa Units: Unification of Different Basicity Scales” J. Org. Chem. 2005, Vol. 70, pp. 1019-1028).

### <Conjugate Base>

The conjugate base is not particularly limited, and can be appropriately selected depending on the intended purpose. The conjugate base preferably has a structure represented by the following general formula (4), the structures represented by the following structural formulae (1) to (4), or a structure represented by the following general formula (5).

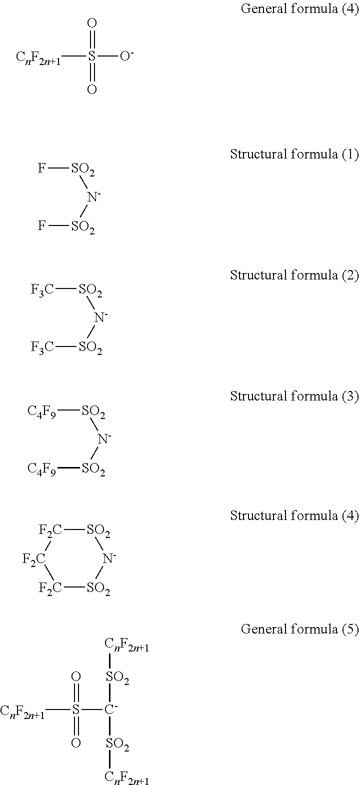

In the general formula (4), n is an integer of 0 or greater.

In the general formula (5), n is an integer of 1 or greater.

“n” in the general formula (4) is not particularly limited as long as n is an integer of 0 or greater, and can be appropriately selected depending on the intended purpose. “n” is preferably from 0 to 10, more preferably from 0 to 6, and particularly preferably from 0 to 3.

“n” in the general formula (5) is not particularly limited as long as n is an integer of 1 or greater, and can be appropriately selected depending on the intended purpose. “n” is preferably from 1 to 10, more preferably from 1 to 6, and particularly preferably from 1 to 3.

An acid that is a source of the conjugate base is not particularly limited, as long as pKa of the acid in water is 0 or less, and can be appropriately selected depending on the intended purpose. The acid is preferably Bronsted acid (HX), pKa of which is 0 or less. Examples of such Bronsted acid include bis[(trifluoromethyl)sulfone]imide [(CF₃SO₂)₂NH], methide, and sulfonic acid. Examples of the sulfonic acid include trifluoromethanesulfonic acid (CF₃SO₃H), sulfuric acid (H₂SO₄), methanesulfonic acid (CH₃SO₃H), and perfluorooctane sulfonate (C₈F₁₇SO₃H).

The pKa of the Bronsted acid is preferably 0 or less, and more preferably from −18 to −2.

Examples of an acid that is a source of the conjugate base include organic acids disclosed in Table 2 of the non-patent literature (Agnes Kutt, Toomas Rodima, Jaan Saame, Elin Raamat, Vahur Maemets, Ivari Kaljurand, Ilmar A. Koppel,* Romute Yu. Garlyauskayte, Yurii L. Yagupolskii, Lev M. Yagupolskii, Eduard Bernhardt, Helge Willner, and Ivo Leito, “Equilibrium Acidities of Superacids”, J. Org. Chem. 2011, Vol. 76, pp. 391-395).

The ionic liquid is preferably represented by any one of the following general formulae (1) to (3).

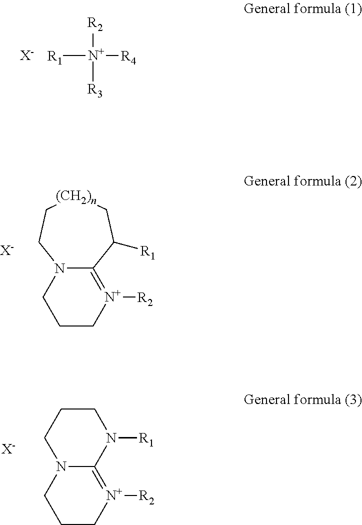

In the general formula (1), R₁, R₂, R₃, and R₄ are groups other than hydrogen atoms, and at least one of R₁, R₂, R₃, and R₄ is a group containing a straight-chain hydrocarbon group having 10 or more carbon atoms.

In the general formula (2), R₁ is a group containing a straight-chain hydrocarbon group having 10 or more carbon atoms, R₂ is a group other than a hydrogen atom, and n is 0 or 1.

In the general formula (3), R₁ is a group containing a straight-chain hydrocarbon group having 10 or more carbon atoms, and R₂ is a group other than a hydrogen atom.

The conjugate acids in the general formulae (2) and (3) may have other resonance structures (canonical structures). Specifically, the conjugate acids can have resonance structures (canonical structures), in which another nitrogen atom is positively charged, and R₂ is bonded to the nitrogen atom. In the present invention, a conjugate acid having such a resonance structure (a canonical structure) is also included in the conjugate acid represented by the general formula (2) and the conjugate acid represented by the general formula (3).

Examples of the group other than a hydrogen atom as R₁, R₂, R₃, and R₄ in the general formula (1) include an aryl group, a cycloalkyl group, and an alkyl group. Examples of the alkyl group include an alkyl group having from 1 to 20 carbon atoms. Among R₁, R₂, R₃, and R₄, a group other than the group containing a straight-chain hydrocarbon group having 10 or greater carbon atoms is preferably an alkyl group having from 1 to 6 carbon atoms.

Examples of R₂ in the general formulae (2) and (3) include an alkyl group. The alkyl group is preferably an alkyl group having from 1 to 20 carbon atoms, and more preferably an alkyl group having from 1 to 6 carbon atoms.

A synthesis method of the ionic liquid is not particularly limited, and can be appropriately selected depending on the intended purpose. Examples of the synthesis method include: a method where a metal salt of an organic acid, such as perfluoroalkane sulfonic acid, and a quaternary ammonium salt are blended in the equivalent amounts to synthesize; and a method where an organic base is quaternized with methyl trifluorosulfonate.

The ionic liquid may be used alone as the lubricant, or the ionic liquid may be used in combination with a conventional lubricant. Examples of the conventional lubricant include long-chain carboxylic acid, long-chain carboxylic acid ester, perfluoroalkyl carboxylic acid ester, perfluoroalkyl carboxylate, perfluoroalkyl perfluoroalkylcarboxylate, and a perfluoropolyether derivative.

Moreover, an extreme pressure agent may be used in combination at a blending ratio of about 30:70 to 70:30 in a mass ratio in order to maintain a lubricating effect under severe conditions. The extreme pressure agent reacts with a surface of a metal with friction heat generated when the lubricant is partially in contact with the metal in a boundary lubrication region, and forms a coating film of a reaction product. As a result, friction and abrasion are prevented. As the extreme pressure agent, for example, any of a phosphorus-based extreme pressure agent, a sulfur-based extreme pressure agent, a halogen-based extreme pressure agent, an organic metal-based extreme pressure agent, or a complex extreme pressure agent can be used.

Moreover, an anti-rust agent may be optionally used in combination. The anti-rust agent may be any anti-rust agent typically used for this kind of magnetic recording media. Examples of the anti-rust agent include phenols, naphthols, quinones, heterocyclic compounds containing a nitrogen atom, heterocyclic compounds containing an oxygen atom, and heterocyclic compounds containing a sulfur atom. Moreover, the anti-rust agent may be mixed with the lubricant. Alternatively, the anti-rust agent and the lubricant may be deposited as two or more layers by forming a magnetic layer on a non-magnetic support, and applying an anti-rust agent layer on the upper part of the magnetic layer, followed by applying a lubricant layer.

As a solvent of the lubricant, for example, a single use or a combination of alcoholic solvents, such as isopropyl alcohol (IPA), and ethanol, can be used. For example, a mixture of a hydrocarbon-based solvent, such as normal-hexane, and a fluorine-based solvent can be used.

### (Magnetic Recording Medium)

A magnetic recording medium of the present invention includes a non-magnetic support, a magnetic layer, and the lubricant of the present invention, and may further include other members according to the necessity.

The magnetic layer is formed on the non-magnetic support.

The lubricant is formed on the magnetic layer.

The lubricant can be applied for so-called a thin film-metal-type magnetic recording medium, in which a magnetic layer formed on a non-magnetic support by a method, such as vapor deposition and sputtering. Moreover, the lubricant can be also applied for a magnetic recording medium having a structure, in which a base layer is disposed between a non-magnetic support and a magnetic layer. Examples of such a magnetic recording medium include a magnetic disk, and a magnetic tape.

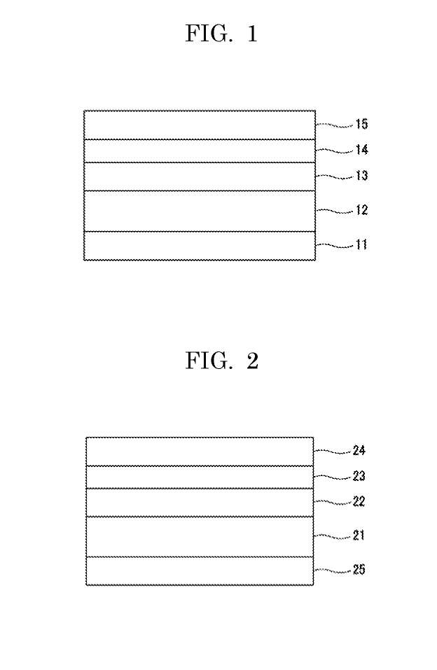

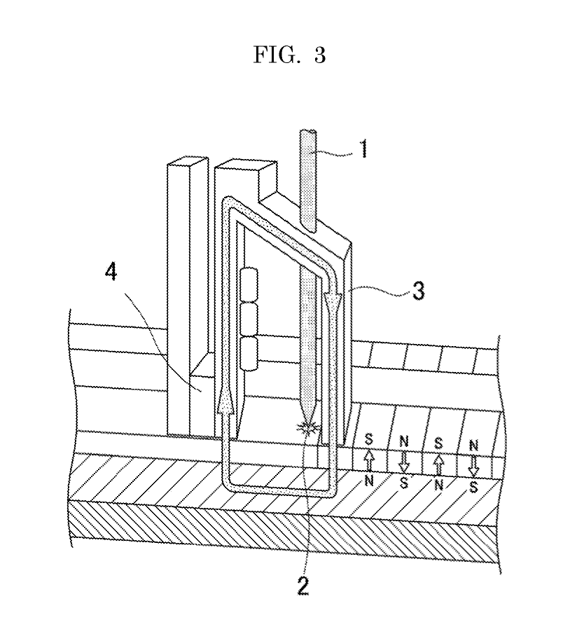

FIG. 1 is a cross-sectional view illustrating one example of a hard disk. The hard disk has a structure, in which a substrate 11, a base layer 12, a magnetic layer 13, a protective carbon layer 14, and a lubricant layer 15 are sequentially laminated.

Moreover, FIG. 2 is a cross-sectional view illustrating one example of a magnetic tape. The magnetic tape has a structure, in which a back-coating layer 25, a substrate 21, a magnetic layer 22, a protective carbon layer 23, and a lubricant layer 24 are sequentially laminated.

In the magnetic disk illustrated in FIG. 1, each of the substrate 11 and the base layer 12 corresponds to the non-magnetic support. In the magnetic tape illustrated in FIG. 2, the substrate 21 corresponds to the non-magnetic support. In the case where a rigid substrate, such as an Al alloy plate, and a glass plate, is used as the non-magnetic support, a surface of the substrate may be made hard by forming an oxidized film, such as anodizing or a Ni—P coating on the surface of the substrate.

Each of the magnetic layers 13 and 22 is formed as a continuous film by a method, such as plating, sputtering, vacuum deposition, and plasma CVD. Examples of the magnetic layers 13 and 22 include: longitudinal magnetic recording metal magnetic films formed of metals (e.g., Fe, Co, and Ni), Co—Ni-based alloys, Co—Pt-based alloys, Co—Ni—Pt-based alloys, Fe—Co-based alloys, Fe—Ni-based alloys, Fe—Co—Ni-based alloys, Fe—Ni—B-based alloys, Fe—Co—B-based alloys, or Fe—Co—Ni—B-based alloys; and perpendicular magnetic recording metal magnetic thin films, such as Co—Cr-based alloy thin films, and Co—O-based thin films.

In the case where a longitudinal magnetic recording metal magnetic thin film is formed, particularly, a non-magnetic material, such as Bi, Sb, Pb, Sn, Ga, In, Ge, Si, and Tl, is formed as a base layer 12 on a non-magnetic support in advance, and a metal magnetic material is deposited through vapor deposition or sputtering in a perpendicular direction to diffuse the non-magnetic material into the magnetic metal thin film, to thereby improve a coercive force as well as eliminating orientation to assure in-plane isotropy.

Moreover, a hard protective layer 14 or 23, such as a carbon film, a diamond-formed carbon film, a chromium oxide film, and SiO₂ film, may be formed on a surface of the magnetic layer 13 or 22.

Examples of a method for applying the above-mentioned lubricant to such a metal thin film magnetic recording medium include a method for top-coating a surface of the magnetic layer 13 or 22, or a surface of the protective layer 14 or 23 with the lubricant, as illustrated in FIGS. 1 and 2. A coating amount of the lubricant is preferably from 0.1 mg/m² to 100 mg/m², and more preferably from 0.2 mg/m² to 3 mg/m².

As illustrated in FIG. 2, moreover, a metal thin film magnetic tape may optionally have a back-coating layer 25, other than a metal magnetic thin film, which is the magnetic layer 22, as illustrated in FIG. 2.

The back-coating layer 25 is formed by adding a carbon-based powder for imparting conductivity, or an inorganic pigment for controlling a surface roughness to a resin binder, and applying the resin binder mixture. In the present embodiment, the above-described lubricant may be internally added to the back-coating layer 25, or applied to the back-coating layer 25 as top coating. Moreover, the above-described lubricant may be internally added to both the magnetic layer 22 and the back-coating layer 25, or applied to both the magnetic layer 22 and the back-coating layer 25 as top coating.

As another embodiment, moreover, the lubricant can be applied for a so-called coating-type magnetic recording medium, in which a magnetic coating film is formed as a magnetic layer by applying a magnetic coating material onto a surface of a non-magnetic support. In the coating-type magnetic recording medium, the non-magnetic support, a magnetic powder constituting the magnetic coating film, and the resin binder for use can be selected from any of those known in the art.

Examples of the non-magnetic support include: polymer substrates formed of polymer materials, such as polyesters, polyolefins, cellulose derivatives, vinyl-based resins, polyimides, polyamides, and polycarbonate; metal substrates formed of aluminium alloys, or titanium alloys; ceramic substrates formed of alumina glass; and glass substrates. Moreover, a shape of the non-magnetic support is not particularly limited, and may be any form, such as a tape, a sheet, and a drum. Furthermore, the non-magnetic support may be subjected to a surface treatment to form fine irregularities in order to control surface properties of the non-magnetic support.

Examples of the magnetic powder include: ferromagnetic iron oxide-based particles, such as γ-Fe₂O₃, cobalt-coatedγ-Fe₂O₃; ferromagnetic chromium dioxide; ferromagnetic metal-based particles formed of a metal, such as Fe, Co, and Ni, or an alloy containing any of the above-listed metals; and hexagonal ferrite particles in the form of hexagonal plates.

Examples of the resin binder include: polymers, such as vinyl chloride, vinyl acetate, vinyl alcohol, vinylidene chloride, acrylic acid ester, methacrylic acid ester, styrene, butadiene, and acrylonitrile; copolymers combining two or more selected from the above-listed polymers; polyurethane resins; polyester resins; and epoxy resins. In order to improve dispersibility of the magnetic powder, a hydrophilic polar group, such as a carboxylic acid group, a carboxyl group, and a phosphoric acid group, may be introduced into any of the above-listed binders.

Other than the magnetic powder and the resin binder, additives, such as a dispersing agent, an abrasive, an antistatic agent, and an anti-rust agent, may be added to the magnetic coating film.

As a method for retaining the above-described lubricant in the coating-type magnetic recording medium, there are a method where the lubricant is internally added to the magnetic layer constituting the magnetic coating film formed on the non-magnetic support, a method where the lubricant is applied on a surface of the magnetic layer as top coating, and a combination of the above-listed methods. In the case where the lubricant is internally added into the magnetic coating film, the lubricant is added in an amount of from 0.2 parts by mass to 20 parts by mass relative to 100 parts by mass of the resin binder.

In the case where a surface of the magnetic layer is top-coated with the lubricant, moreover, a coating amount of the lubricant is preferably from 0.1 mg/m² to 100 mg/m², and more preferably from 0.2 mg/m² to 3 mg/m². As a deposition method in the case where the lubricant is applied as top coating, the ionic liquid is dissolved in a solvent, and the obtained solution may be applied or sprayed, or a magnetic recording medium may be dipped in the solution

Since the lubricant of the present invention is used, in the present embodiment, an excellent lubricating effect is exhibited to reduce a coefficient of friction, and high thermal stability can be achieved. Moreover, the lubricating effect is not impaired even under severe conditions, such as high temperatures, low temperatures, high humidity, and low humidity.

Accordingly, the magnetic recording medium, to which the lubricant of the present embodiment is applied, exhibits excellent running performances, abrasion resistance, and durability because of a lubricating effect, and can further improve thermal stability.

### EXAMPLES

Specific examples of the present invention are explained below. In the examples, ionic liquids were synthesized, and lubricants including the ionic liquids were produced. Then, magnetic disks and magnetic tapes were produced using the lubricants and durability of each disk and durability of each tape were evaluated. Production of a magnetic disk, a durability test of the disk, production of a magnetic tape, and a durability test of the tape were performed in the following manner. Note that, the present invention is not limited to these examples.

### <Production of Magnetic Disk>

A magnetic thin film was formed on a glass substrate to produce a magnetic disk as illustrated in FIG. 1, for example, according to International Patent Publication No. WO2005/068589. Specifically, a chemically reinforced glass disk, which was formed of aluminium silicate glass and had an outer diameter of 65 mm, an inner diameter of 20 mm, and a disk thickness of 0.635 mm, was prepared, and a surface of the glass disk was polished so that Rmax of the surface was to be 4.8 nm, and Ra of the surface was to be 0.43 nm. The glass substrate was subjected to ultrasonic cleaning for 5 minutes each in pure water and in isopropyl alcohol (IPA) having the purity of 99.9% or greater, and the washed glass substrate was left to stand in saturated IPA steam for 1.5 minutes, followed by drying. The resultant glass substrate was provided as a substrate 11.

On the substrate 11, a NiAl alloy (Ni: 50 mol %, Al: 50 mol %) thin film in the thickness of 30 nm as a seed layer, a CrMo alloy (Cr: 80 mol %, Mo: 20 mol %) thin film in the thickness of 8 nm as a base layer 12, and a CoCrPtB alloy (Co: 62 mol %, Cr: 20 mol %, Pt: 12 mol %, B: 6 mol %) thin film in the thickness of 15 nm as a magnetic layer 13 were sequentially formed by DC magnetron sputtering.

Subsequently, a 5 nm-thick protective carbon layer 14 formed of amorphous diamond-like carbon was formed by plasma CVD, and the resultant disk sample was subjected to ultrasonic cleaning for 10 minutes in isopropyl alcohol (IPA) having the purity of 99.9% or greater inside a cleaner to remove impurities on a surface of the disk, followed by drying. Thereafter, an IPA solution of an ionic liquid was applied on a surface of the disk by dip coating in the environment of 25° C. and 50% in relative humidity (RH), to form about 1 nm of a lubricant layer 15.

### <Disk Durability Test>

A CSS durability test was performed by means of a commercially available strain-gauge-type disk friction-abrasion tester in the following manner. A hard disk was mounted on a rotatable spindle with tightening torque of 14.7 Ncm. Thereafter, a head slider was attached on the hard disk in a manner that a center of an air bearing surface at the inner circumference side of the head slider relative to the hard disk was 17.5 mm from a center of the hard disk. The head used for the measurement was an IBM3370-type inline head, a material of the slider was Al₂O₃—TiC, and the head load was 63.7 mN. In the test, the maximum value of friction force was monitored per CSS (contact, start, and stop) in the environment of 100 in cleanliness, 25° C., and 60% RH. The number of times when a coefficient of friction was greater than 1.0 was determined as a result of the CSS durability test. When a result of the CSS durability test was greater than 50,000, the result was represented as “>50,000.” Moreover, a CSS durability test was similarly performed after performing a heating test for 3 minutes at a temperature of 300° C., in order to study heat resistance.

### <Production of Magnetic Tape>

A magnetic tape having a cross-sectional structure as illustrated in FIG. 2 was produced. First, Co was deposited on a substrate 21 formed of a 5 μm-thick MICTRON (aromatic polyamide) film available from TORAY INDUSTRIES, INC. by oblique deposition to form a magnetic layer 22 formed of a ferromagnetic metal thin film having a film thickness 100 nm. Next, a protective layer 23 formed of a 10 nm-thick diamond-like carbon was formed on a surface of the ferromagnetic metal thin film by plasma CVD, followed by cutting the resultant into a strip having a width of 6 mm. An ionic liquid dissolved in IPA was applied onto the magnetic layer 22 in a manner that a film thickness of the ionic liquid solution was about 1 nm. In this manner, a lubricant layer 24 is formed on the magnetic layer to thereby produce a sample tape.

### <Tape Durability Test>

Each sample tape was subjected to a measurement of still durability in an environment having a temperature of −5° C. and in an environment having a temperature of 40° C. and 30% RH, and measurements of a coefficient of friction and shuttle durability in an environment having a temperature of −5° C. and in an environment having a temperature of 40° C. and 90% RH. The still durability was evaluated by a decay time of an output in a paused state decayed by −3 dB. The shuttle resistant was evaluated by the number of shuttles taken until an output was reduced by 3 dB when repeated shuttle run was performed for 2 minutes per time. Moreover, a durability test was similarly performed after performing a heating test for 10 minutes at a temperature of 100° C., in order to study heat resistance.

### Example 1

### Synthesis of TBD-C₁₈H₃₇-methyl trifluoromethanesulfonate

First, synthesis of 7-n-octadecyl-1,5,7-triazabicyclo[4.4.0]-5-decene (TBD-C₁₈H₃₇) is described.

TBD-C₁₈H₃₇ was synthesized with reference to the method of R. W. Alder et at (non-patent literature, Roger W. Alder, Rodney W. Mowlam, David J. Vachon and Gray R. Weisman, “New Synthetic Routes to Macrocyclic Triamines,” J. Chem. Sos. Chem. Commun. pp. 507-508 (1992)).

Specifically, sodium hydride (55% by mass hexane) was added at 10° C. to 8.72 g of 1,5,7-triazabicyclo[4.4.0]-5-decene (TBD) dissolved in dry THF, and the resultant mixture was stirred. With maintain the temperature at 10° C., bromooctadecane was added to the mixture by dripping over 20 minutes. Thereafter, the resultant was stirred for 30 minutes at 10° C., followed by stirred for 2 hours at room temperature. Thereafter, the resultant was heated to reflux for 1 hour. The resultant was then returned to room temperature, and an excessive amount of sodium hydride was added to the resultant to allow the mixture to react. After removing the solvent from the reaction mixture, the resultant was subjected to column chromatography using amino-treated silica gel, to thereby obtain a pale yellow target.

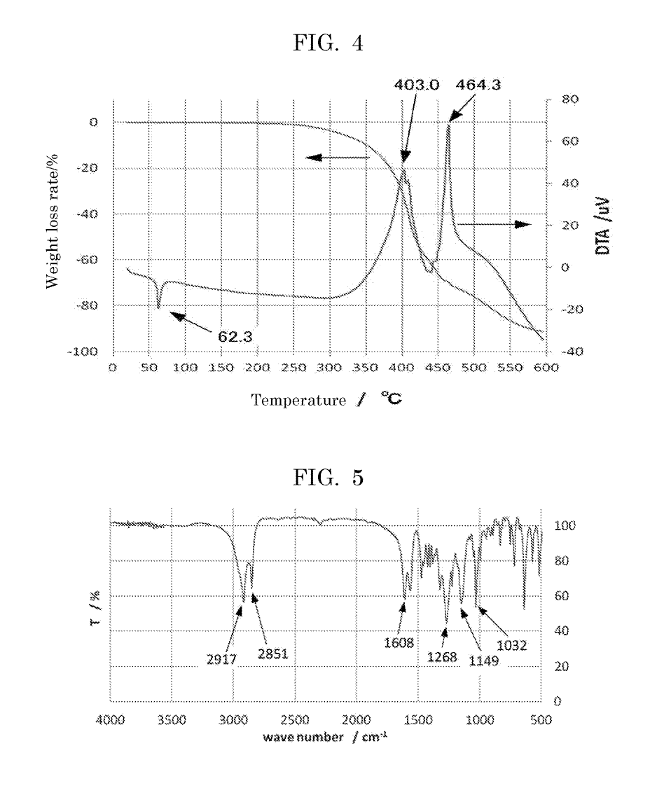

Next, synthesis of TBD-C₁₈H₃₇-methyl trifluoromethanesulfonate is described below. 7-n-octadecyl-1,5,7-triazabicyclo[4.4.0]-5-decene (TBD-C₁₈H₃₇) was dissolved in ethyl acetate. To the resultant solution, a solution, in which methyl trifluoromethanesulfonate was dissolved in ethyl acetate, was added. The resultant mixture was allowed to react for 4 hours at a reaction temperature of 40° C. After removing the solvent from the reaction mixture, the resultant was recrystallized with a mixed solvent of n-hexane and ethanol to thereby obtain a product. The obtained product was colorless crystals, and had a melting point of 62.3° C. The TG/DTA of the product and the FTIR spectrum of the product are respectively depicted in FIGS. 4 and 5.

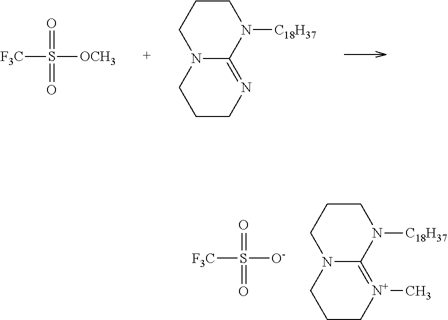

In the present specification, the measurement of FTIR was performed by means of FT/IR-460 available from JASCO Corporation according to a transmission method using KBr plates or KBr pellets. The resolution of the measurement was 4 cm⁻¹.

In the TG/DTA measurement, the measurement was performed by means of EXSTAR6000 available from Seiko Instruments Inc. at a temperature range of from 30° C. to 600° C. at a heating rate of 10° C./min with introducing air at a flow rate of 200 mL/min.

The absorption wavelength of IR and the assignment are depicted in Table 2. The structure of the product was determined based on that symmetric stretching vibrations of SO₂ were observed at 1,032 cm⁻¹, asymmetric stretching vibrations of SO₂ bonds were observed at 1,149 cm⁻¹, symmetric stretching vibrations of CF₃ were observed at 1,268 cm⁻¹, stretching vibrations of C═N bonds were observed at 1,608 cm⁻¹, symmetric stretching vibrations of CH₂ were observed at 2,851 cm⁻¹, and asymmetric stretching vibrations of CH₂ were observed at 2,917 cm⁻¹.

Moreover, it was suggested from TG/DTA that it was a decomposition reaction of the compound because the exothermic temperatures due to weight loss were extremely high, i.e., 403.0° C. and 464.3° C., and the weight loss was exothermic.

TABLE 2

| Band | Assignment |
|---|---|
| 1,032 cm⁻¹ | νₛ**SO₂ |
| 1,149 cm⁻¹ | νₐₛSO₂ |
| 1,268 cm⁻¹ | νₛCF₃ |
| 1,608 cm⁻¹ | νC═N |
| 2,851 cm⁻¹ | νₐCH₂ |
| 2,917 cm⁻¹ | νₐₛCH₂ |

Moreover, the measurement result of ¹³C-NMR and measurement result of ¹H-NMR are presented below.

The ¹H-NMR spectrum was measured by means of Varian Mercury Plus 300 nuclear magnetic resonance spectrometer (available from Varian, Inc.). A chemical shift of ¹H-NMR was represented with a unit of ppm using a solvent peak at 7.24 ppm as an internal standard in the case where deuterated chloroform was used, or using tetramethylsilane (TMS) as an internal standard in the case where deuterated methanol was used. Splitting patterns were described by denoting a singlet as s, a doublet as d, a triplet as t, a multiplet as m, and a broad peak as br.

The ¹³C-NMR spectrum was measured by means of Varian Gemini-300 (125 MHz) nuclear magnetic resonance spectrometer (available from Varian, Inc.), and a chemical shift was represented with a unit of ppm using a peak of CDCl₃ at 77.0 ppm as an internal standard or in comparison with TMS.

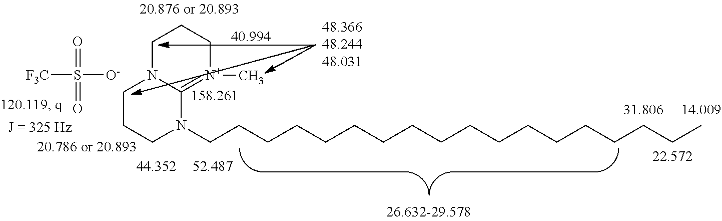 [SMILES: O=S(=O)([O-])C(F)(F)F ; CCCCCCCCCCCCCCCCCCN1CCCN2CCC[N+](C)=C12]

TABLE 3
Chemical shift (CMR)/ppm
158.261
120.119, J = 325 Hz
52.487
48.366
48.244
48.031
44.352
40.994
31.806
29.578
29.547
29.425
29.242
29.150
27.517
26.632
22.572
20.893
20.786
14.009

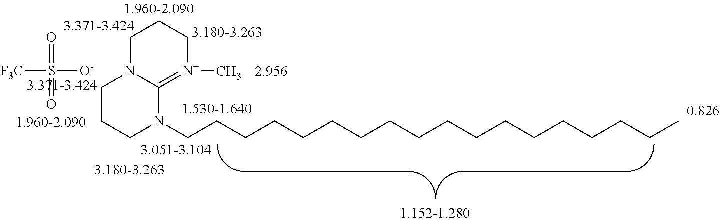 [SMILES: O=S(=O)([O-])C(F)(F)F ; CCCCCCCCCCCCCCCCCCN1CCCN2CCC[N+](C)=C12]

TABLE 4

| Chemical shift (PMR)/ppm | CDCl₃ | |
|---|---|---|
| 3.555 | br | s |
| 3.371-3.424 | 4H | m |
| 3.180-3.263 | 4H | m |
| 3.051-3.104 | 2H | m |
| 2.956 | 3H | s |
| 1.960-2.090 | 4H | m |
| 1.530-1.640 | m/2H | |
| 1.152-1.280 | m/30H | |
| 0.826 | 3H | t |

### Example 2

### Synthesis of DBU-C₁₈H₃₇-methyl trifluoromethanesulfonate

First, synthesis of DBU-C₁₈H₃₇ is described.

DBU-C₁₈H₃₇ was synthesized with reference to the method of Matsumura et. Al. (non-patent literature, Noboru Matsumura, Hiroshi Nishiguchi, Masao Okada, and Shigeo Yoneda, “Preparation and Characterization of 6-Substituted 1,8-diazabicyclo[5.4.0]undec-7-ene,” J. Heterocyclic Chemistry Vol. 23, Issue 3, pp. 885-887 (1986)).

Specifically, 7.17 g of a raw material, which was 1,8-diazabicyclo[5.4.0]-7-undecene (DBU) was dissolved in a tetrahydrofuran (THF) solution, and the resultant solution was cooled down to 0° C. To the solution, 29 cc of n-butyl lithium having a concentration of 1.64 mol/L was added by dripping in an argon gas atmosphere, and the resultant mixture was stirred for 1 hour at 0° C. To the obtained solution, a solution, in which 15.71 g of octadecyl bromide was dissolved in THF, was added by dripping, followed by leaving the resultant mixture for 24 hours with stirring. Note that, THF, which had been prepared by drying in a type 4A molecular sieve, followed by distillation purification, was used immediately after the preparation. After adjusting the resultant mixture to be acidic with hydrochloric acid, the solvent was removed from the mixture, and the resultant was dissolved in hexane. The solution was purified by performing column chromatography using amino-treated silica gel to thereby obtain colorless crystals. The yield was 90%.

The synthesis scheme is presented below.

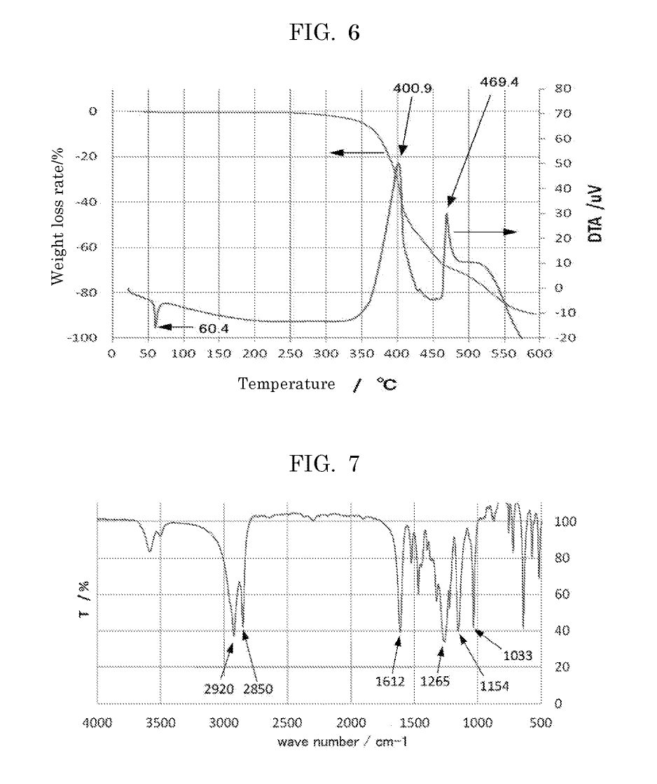

6-n-Octadecyl-1,8-diazabicyclo[5.4.0]undecene (DBU-C₁₈H₃₇) was dissolved in ethyl acetate. To the resultant solution, a solution, in which methyl trifluoromethanesulfonate was dissolved in ethyl acetate, was added. The resultant mixture was allowed to react for 4 hours at a reaction temperature of 40° C. After removing the solvent from the reaction mixture, the reaction mixture was recrystallized using a mixed solvent of n-hexane and ethanol to thereby obtain a product. The obtained product was colorless crystals and had a melting point of 60.4° C. The TG/DTA of the product and the FTIR spectrum of the product are respectively depicted in FIGS. 6 and 7.

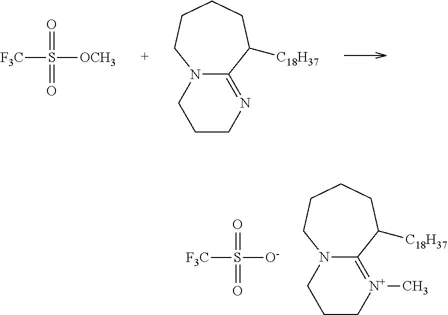

The absorption wavelength of IR and the assignment are depicted in Table 5. The structure of the product was determined based on that symmetric stretching vibrations of SO₂ were observed at 1,033 cm⁻¹, asymmetric stretching vibrations of SO₂ bonds were observed at 1,154 cm⁻¹, symmetric stretching vibrations of CF₃ were observed at 1,265 cm⁻¹, stretching vibrations of C═N bonds were observed at 1,612 cm⁻¹, symmetric stretching vibrations of CH₂ were observed at 2,850 cm⁻¹, and asymmetric stretching vibrations of CH₂ were observed at 2,920 cm⁻¹.

Moreover, it was suggested from TG/DTA that it was a decomposition reaction of the compound because the exothermic temperatures due to weight loss were extremely high, i.e., 400.9° C. and 469.4° C., and the weight loss was exothermic.

TABLE 5

| Band | Assignment |
|---|---|
| 1,033 cm⁻¹ | νₛ**SO₂ |
| 1,154 cm⁻¹ | νₐₛ* SO₂ |
| 1,265 cm⁻¹ | νₛCF₃ |
| 1,612 cm⁻¹ | νC═N |
| 2,850 cm⁻¹ | νₛCH₂ |
| 2,920 cm⁻¹ | νₐₛCH₂ |

Moreover, the measurement result of ¹³C-NMR and measurement result of ¹H-NMR of the obtained compound are presented below.

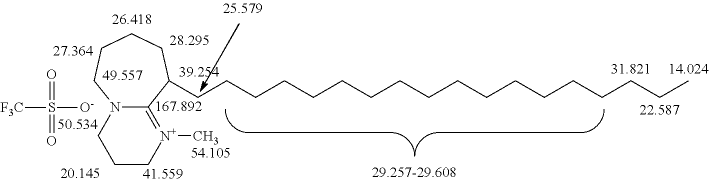 [SMILES: O=S(=O)([O-])C(F)(F)F ; CCCCCCCCCCCCCCCCCCC1CCCCN2CCC[N+](C)=C12]

TABLE 6
Chemical shift (CMR)/ppm
120.782, J = 319 Hz
167.892
54.105
50.534
49.557
41.559
39.254
31.821
29.608
29.562
29.516
29.455
29.349
29.257
28.295
27.364
26.418
25.579
22.587
21.854 (unknown)
20.145
14.024

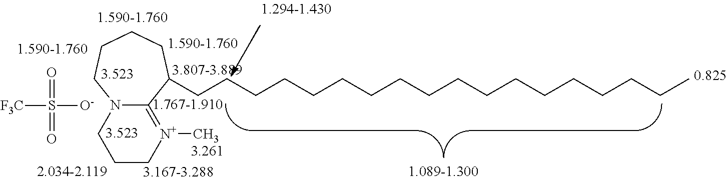 [SMILES: O=S(=O)([O-])C(F)(F)F ; CCCCCCCCCCCCCCCCCCC1CCCCN2CCC[N+](C)=C12]

TABLE 7

| Chemical shift (PMR)/ppm | CDCl₃ | |
|---|---|---|
| 3.807-3.889 | 1H | m |
| 3.523 | 4H t/7 Hz | |
| 3.167-3.288 | 2H, | m |
| 3.261 | 3H | s |
| 2.034-2.119 | 2H | m |
| 1.767-1.910 | 2H | m |
| 1.590-1.760 | 6H | m |
| 1.294-1.430 | 2H | m |
| 1.089-1.300 | 30H | m |

| | |
|---|---|
| 0.825 | 3H t/9 Hz |

### Example 3

### Synthesis of tris(trifluoromethylsulfonyl)methide trimethylstearyl ammonium salt

The synthesis scheme is presented below.

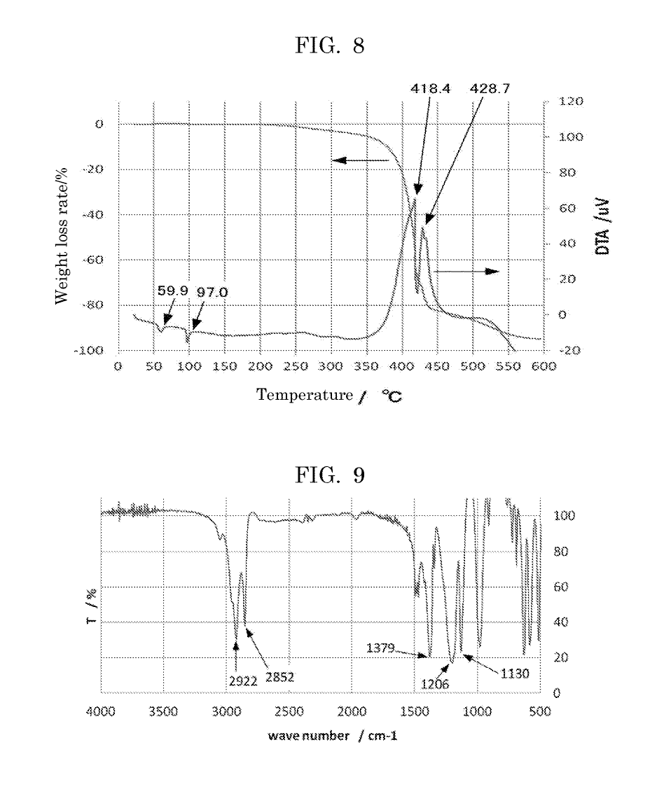

Tris(trifluoromethylsulfonyl)methide potassium salt (4.53 g) was dissolved in ethanol. To the resultant solution, a solution, in which 4.35 g of n-octadecyltrimethyl ammonium chloride was dissolved in ethanol, was added. The resultant was heated to reflux for 60 minutes, and then cooled. After the cooling, the resultant was added into distilled water to perform ether extraction. The organic layer was washed with distilled water. Thereafter, the organic layer was dried with anhydrous sodium sulfate. After removing the solvent from the organic layer, the resultant was recrystallized using a mixed solvent of n-hexane/ethanol, to thereby obtain a product. The obtained product was colorless crystals and had a melting point of 59.9° C. The TG/DTA of the product and the FTIR spectrum of the product are respectively depicted in FIGS. 8 and 9.

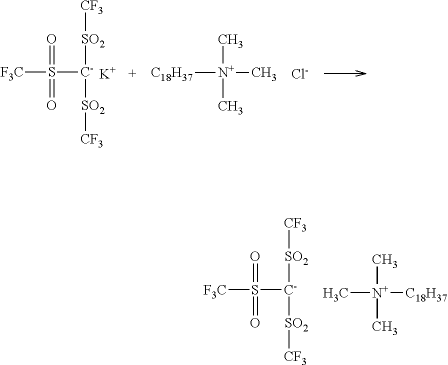

The absorption wavelength of IR and the assignment are depicted in Table 8. The structure of the product was determined based on that symmetric stretching vibrations of SO₂ bonds were observed at 1,130 cm⁻¹, symmetric stretching vibrations of CF₃ were observed at 1,206 cm⁻¹, asymmetric stretching vibrations of SO₂ bond were observed at 1,379 cm⁻¹, symmetric stretching vibrations of CH₂ were observed at 2,852 cm⁻¹, and asymmetric stretching vibrations of CH₂ were observed at 2,922 cm⁻¹.

Moreover, it was suggested from TG/DTA that it was a decomposition reaction of the compound because the exothermic temperatures due to weight loss were extremely high, i.e., 418.4° C. and 428.7° C., and the weight loss was exothermic.

TABLE 8

| Band | Assignment |
|---|---|
| 1,130 cm⁻¹ | νₛ* SO₂ |
| 1,206 cm⁻¹ | νₛCF₃ |
| 1,379 cm⁻¹ | νₐₛ* SO₂ |
| 2,852 cm⁻¹ | νₛCH₂ |
| 2,922 cm⁻¹ | νₐₛCH2 |

Moreover, the measurement result of ¹³C-NMR and measurement result of ¹H-NMR of the obtained compound are presented below.

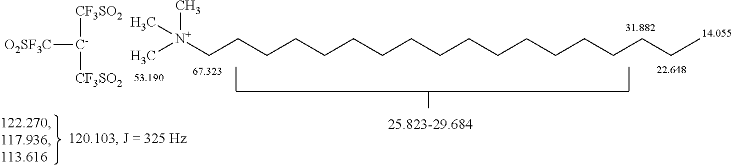

TABLE 9
Chemical shift (CMR)/ppm
120.103, J = 325 Hz
67.323
53.190
31.882
29.684
29.623
29.547
29.379
29.333
29.257
28.952
25.823
22.969
22.648
14.055

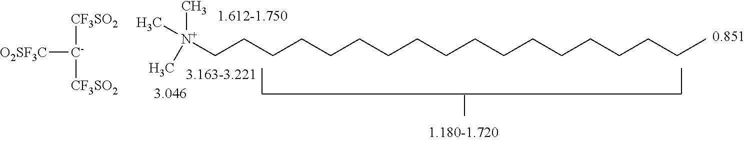

TABLE 10

| Chemical shift (PMR)/ppm | CDCl₃ | |
|---|---|---|
| 3.163-3.221 | 2H | m |
| 3.046 | 9H | s |
| 1.612-1.750 | 2H | m |
| 1.180-1.720 | 30H | m |
| 0.851 | 3H | t |

### Example 4

### Synthesis of hexafluorocyclopropylbissulfonylimide trimethylstearyl ammonium salt

Next, synthesis of hexafluorocyclopropylbissulfonylimide trimethylstearyl ammonium salt is presented below.

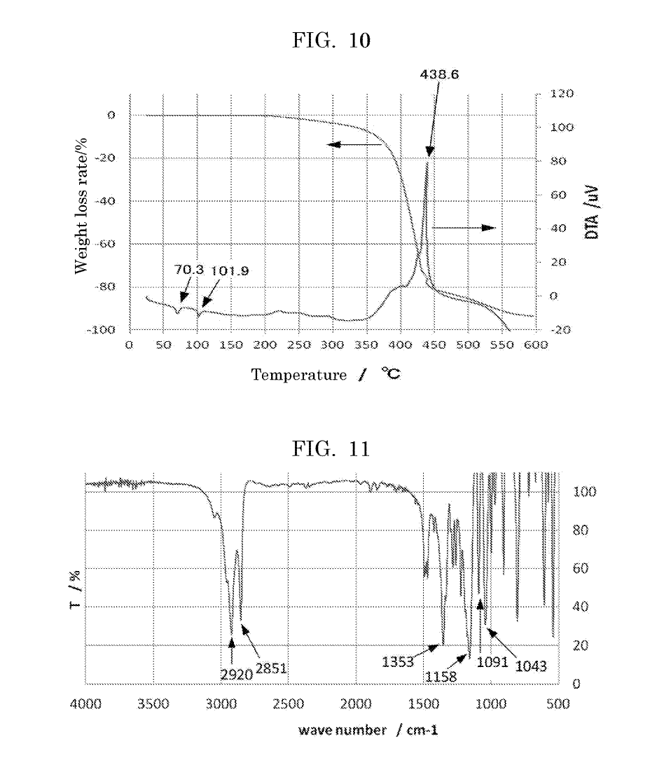

Hexafluorocyclopropyl bissulfoimide (5.0 g) was dissolved in ethanol upon heating. To the resultant solution, a solution obtained by dissolving 6.56 g of trimethylstearyl ammonium chloride in ethanol was added. The resultant mixture was subjected to reflux for 60 minutes. After cooling the resultant, the solvent was removed and water was added to perform ether extraction. The obtained organic layer was washed with distilled water, followed by drying with anhydrous sodium sulfate. After removing the solvent from the organic layer, the resultant was recrystallized using a mixed solvent of n-hexane/ethanol, to thereby obtain a product. The obtained product was colorless crystals and had a melting point of 70.3° C. The TG/DTA of the product and the FTIR spectrum of the product are respectively depicted in FIGS. 10 and 11.

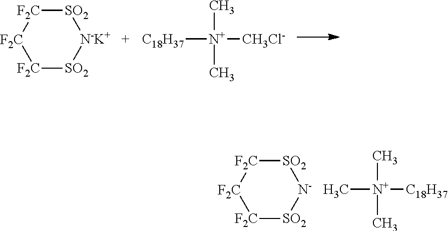

The absorption wavelength of IR and the assignment are depicted in Table 11. The structure of the product was determined based on that asymmetric vibration of SNS was observed at 1,043 cm⁻¹, symmetric vibration of SO₂ was observed at 1,091 cm⁻¹, symmetric stretching vibration of CF₂ was observed at 1,158 cm⁻¹, asymmetric vibration of SO₂ was observed at 1,353 cm⁻¹, symmetric stretching vibration of CH₂ was observed at 2,851 cm⁻¹, and asymmetric stretching vibration of CH₂ was observed at 2,920 cm⁻¹.

Moreover, it was suggested from TG/DTA that it was a decomposition reaction of the compound because the exothermic temperature due to weight loss was extremely high, i.e., 438.6° C., and the weight loss was exothermic.

TABLE 11

| Band | Assignment |
|---|---|
| 1,043 cm⁻¹ | νₐSNS |
| 1,091 cm⁻¹ | νₛSO₂ |
| 1,158 cm⁻¹ | νₛCF₂ |
| 1,353 cm⁻¹ | νₐSO₂ |
| 2,851 cm⁻¹ | νₛCH₂ |
| 2,920 cm⁻¹ | νₐCH₂ |

Moreover, the measurement result of ¹³C-NMR and measurement result of ¹H-NMR of the obtained compound are presented below.

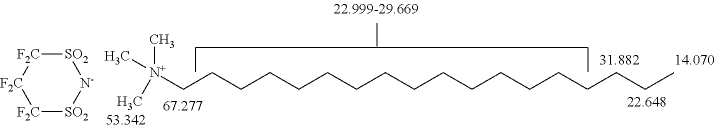 [SMILES: O=S1(=O)[N-]S(=O)(=O)C(F)(F)C(F)(F)C1(F)F ; CCCCCCCCCCCCCCCCCC[N+](C)(C)C]

TABLE 12
Chemical shift (CMR)/ppm

182.743
67.277
53.342
31.882
29.669
29.623
29.562
29.410
29.333
29.288
28.982
25.869
22.999
22.648
14.070

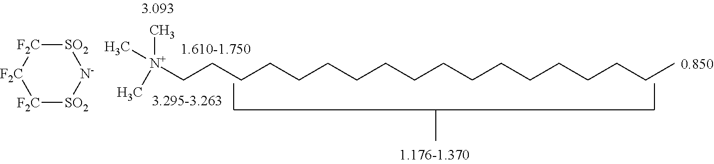 [SMILES: O=S1(=O)[N-]S(=O)(=O)C(F)(F)C(F)(F)C1(F)F ; CCCCCCCCCCCCCCCCCC[N+](C)(C)C]

TABLE 13

| Chemical shift (PMR)/ppm | CDCl₃ | |
|---|---|---|
| 3.295-3.263 | 2H | m |
| 3.093 | 9H | s |
| 1.610-1.750 | 2H | m |

| | |
|---|---|
| 1.176-1.370 | m/30H |
| 0.850 | 3H t/9 Hz |

### Example 5

### Synthesis of trifluoromethanesulfolfonic acid-trimethylstearyl ammonium salt

Dimethyl-n-octadecylamine was dissolved in ethyl acetate, and the resultant solution was heated until the temperature inside the flask was to reach 30° C. To the resultant, an equimolar amount of methyl sulfonate was added little by little. As a result, a colorless substance was precipitated. Thereafter, the resultant was stirred for 4 hours, and the solvent was removed. Thereafter, the resultant was recrystallized using ethanol, to thereby obtain 19.6 g of colorless crystals.

The absorption wavelength of IR and the assignment are depicted in Table 14.

TABLE 14

| Band | Assignment |
|---|---|
| 1,136 cm⁻¹ | νₛSO₂ |
| 1,252 cm⁻¹ | νₛCF₃ |
| 2,850 cm⁻¹ | νₐCH₂ |
| 2,920 cm⁻¹ | νₐₛCH₂ |

Moreover, the measurement result of ¹³C-NMR and measurement result of ¹H-NMR of the obtained compound are presented below.

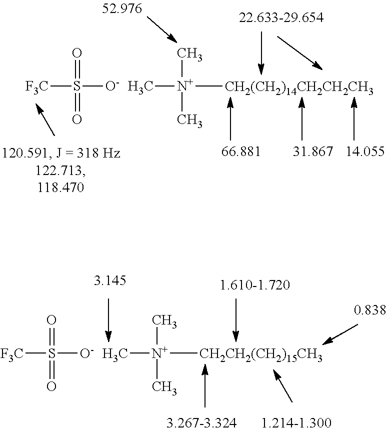

TABLE 15

| Chemical shift (PMR)/ppm | CDCl₃ |
|---|---|
| 3.267-3.324 | m/N-CH₂/2H |
| 3.145 | s/9H |
| 1.610-1.720 | m/2H |
| 1.214-1.300 | m/30H |
| 0.838 | t/3H |

As depicted above, it was confirmed that a trifluoromethanesulfonic acid-trimethylstearyl ammonium salt was obtained.

### Comparative Example 1

Fomblin Z-DOL was used as Comparative Ionic Liquid 1 of Comparative Example 1.

### Comparative Example 2

### Synthesis of hexafluoropropane-1,3-disulfonylimideoctadecyl ammonium salt

The synthesis scheme is presented below.

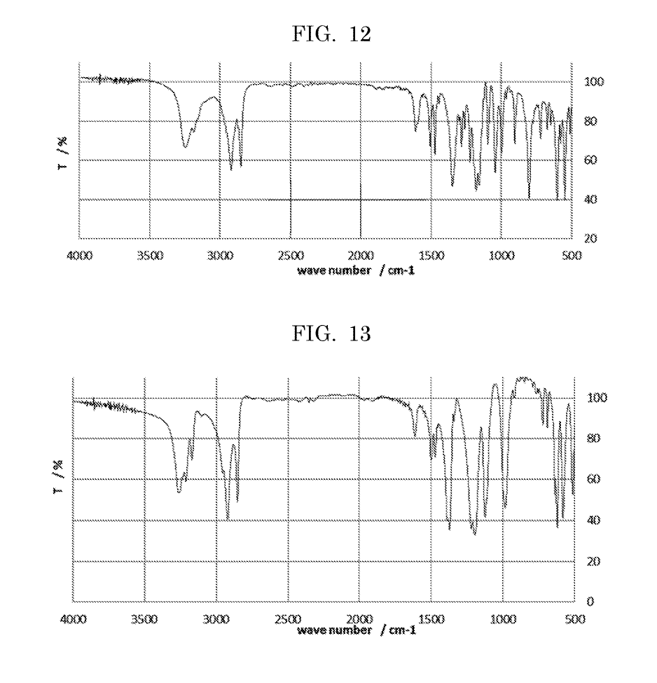

Hexafluorocyclopropane sulfoimide (5.45 g) was dissolved in ethanol. To the resultant solution, a solution, in which 5 g of n-octadecyl amine was dissolved in ethanol, was added. Since heat was generated, the surrounding area of the resultant was cooled with ice. Thereafter, the resultant was heated to reflux for 30 minutes, followed by removing the solvent. Thereafter, the resultant was recrystallized with n-hexane to thereby obtain a product. The obtained product was colorless crystals and had a melting point of 92° C. The FTIR spectrum of the product is depicted in FIG. 12.

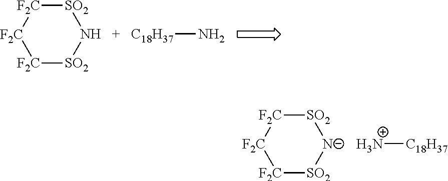

The absorption wavelength of IR and the assignment are depicted in Table 16. The structure of the product was determined based on that symmetric stretching vibrations of S—N—S bonds were observed at 1,043 cm⁻¹, symmetric stretching vibrations of SO₂ bonds were observed at 1,096 cm⁻¹, symmetric stretching vibrations of CF₃ and CF₂ were observed at 1,188 cm⁻¹ and 1,154 cm⁻¹, asymmetric stretching vibrations of SO₂ bonds were observed at 1,348 cm⁻¹, asymmetric bending vibrations of NH₃⁺ were observed at 1,608 cm⁻¹, symmetric stretching vibrations of CH₂ were observed at 2,850 cm⁻¹, asymmetric stretching vibrations of CH₂ were observed at 2,920 cm⁻¹, and broad symmetric stretching vibrations of NH₃⁺ were observed at from 3,350 cm⁻¹ to 3,035 cm⁻¹.

TABLE 16

| Band | Assignment |
|---|---|
| 1,043 cm⁻¹ | νₐSNS |
| 1,096 cm⁻¹ | νₛSO₂ |
| 1,154 cm⁻¹, 1,188 cm⁻¹ | νₛCF₂ |
| 1,348 cm⁻¹ | νₐSO₂ |
| 1,608 cm⁻¹ | σₐₛNH₃⁺ |
| 2,850 cm⁻¹ | νₐCH₂ |
| 2,920 cm⁻¹ | νₐₛCH₂ |
| 3,350-3,035 cm⁻¹ | νₛNH₃⁺ |

### Comparative Example 3

### Synthesis of tris(trifluoromethanesulfonyl)methide stearyl ammonium salt

The synthesis scheme is presented below.

Octadecylamine nitrate, which was a raw material, was synthesized by the following method. Normal-octadecyl amine was dissolved in heated ethanol. To the resultant solution, an equimolar amount of nitric acid was added by dripping, and it was confirmed that the resultant mixture was neutral. Thereafter, the resultant mixture was cooled to precipitate crystals, and the crystals were separated through filtration, followed by drying the filtrate, to thereby obtain octadecyl amine.

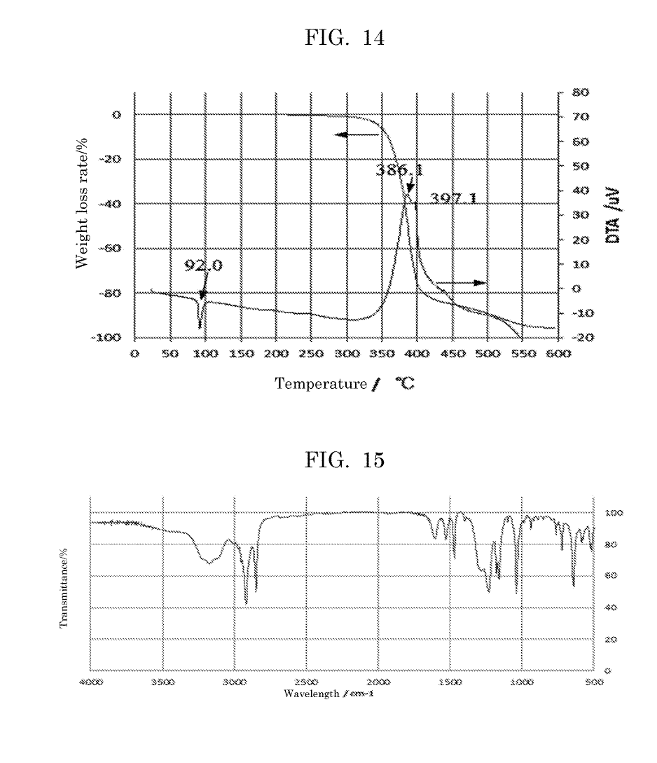

The obtained octadecyl amine nitrate (3.3 g) was dissolved in ethanol. To the resultant solution, a solution, in which 4.5 g of a potassium salt of methide was dissolved in ethanol, was added. Thereafter, the resultant mixture was stirred for 1 hour, and then was heated to reflux for 30 minutes. After removing the solvent, ethanol was added to the resultant to obtain an organic layer. The organic layer was washed with water. Thereafter, the organic layer was dried with anhydrous sodium sulfate to remove ether. The resultant was recrystallized using a mixed solvent of n-hexane and ethanol, to thereby obtain 6.5 g of colorless crystals (melting point: 92.0° C.). The yield was 95%. The FTIR spectrum of the product and the TG/DTA of the product are respectively depicted in FIGS. 13 and 14.

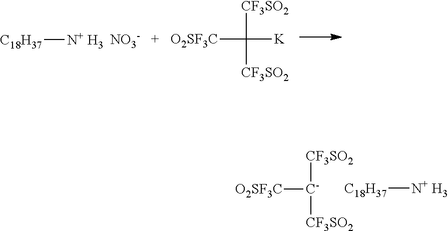

The absorption wavelength of IR and the assignment are depicted in Table 17. Symmetric stretching vibrations of SO₂ were observed at 1,124 cm⁻¹, asymmetric stretching vibrations of SO₂ bonds were observed at 1,371 cm⁻¹, symmetric stretching vibrations of CF₃ were observed at 1,197 cm⁻¹ and 1,220 cm⁻¹, asymmetric bending vibrations of NH bonds were observed at 1,614 cm⁻¹, symmetric stretching vibrations of CH₂ were observed at 2,851 cm⁻¹, asymmetric stretching vibrations of CH₂ were observed at 2,920 cm⁻¹, and stretching vibrations of NH bonds were observed at from 3,170 cm⁻¹ to 3,263 cm⁻¹.

Moreover, it was suggested from TG/DTA that it was a decomposition reaction of the compound because the exothermic peak temperatures due to weight loss were extremely high, i.e., 386.1° C. and 397.1° C., and the weight loss was exothermic.

TABLE 17

| Band | Assignment |
|---|---|
| 1,124 cm⁻¹ | νₛ**SO₂ |
| 1,197 cm⁻¹ | νₛCF₃ |
| 1,220 cm⁻¹ | νₛCF₃ |
| 1,371 cm⁻¹ | νₐₛSO₂ |
| 1,614 cm⁻¹ | σₐₛ***NH⁺ |
| 2,851 cm⁻¹ | νₐCH₂ |
| 2,920 cm⁻¹ | νₐₛCH₂ |
| 3,170-3,263 cm⁻¹ | νₛNH₄⁺ |

Moreover, the measurement result of ¹³C-NMR and measurement result of ¹H-NMR of the obtained compound are presented below.

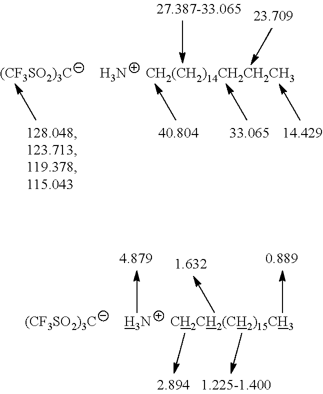 [SMILES: "CH2(CH2)14CH2CH2CH3" ; "(CF3SO2)3C" ; [NH4+] ; "CH2CH2(CH2)15CH3" ; "(CF3SO2)3C" ; [NH4+]]

It was confirmed from the above that tris(trifluoromethanesulfonyl)methide stearyl ammonium salt was obtained.

### Comparative Example 4

### Synthesis of trifluoromethanesulfonic acid stearyl ammonium salt

Normal-octadecylamine, which was a raw material, was dissolved in ethanol. To the resultant solution, an ethanol solution, in which an equimolar amount of trifluoromethanesulfonic acid was dissolved in ethanol, was added at room temperature. After the addition of the ethanol solution, the resultant mixture was stirred for 1 hour, followed by heating to reflux for 30 minutes. After removing the solvent, the resultant was recrystallized using a mixed solvent of n-hexane and ethanol to thereby obtain a product of colorless crystals (melting point: 85° C.). The FTIR spectrum of the product is depicted in FIG. 15.

The absorption wavelength of IR of the obtained compound and the assignment are depicted in Table 18.

TABLE 18

| Band | Assignment |
|---|---|
| 1159 cm⁻¹ | νₛSO₂ |
| 1229 cm⁻¹ | νₛCF_{2,} νₛCF₃ |
| 1603 cm⁻¹ | σₐₛNH₄⁺ |
| 2848 cm⁻¹ | νₛCH₂ |
| 2918 cm⁻¹ | νₐₛCH₂ |
| 3174 cm⁻¹ | νₛNH₄⁺ |

Moreover, the measurement result of ¹³C-NMR and measurement result of ¹H-NMR of the obtained compound are presented below.

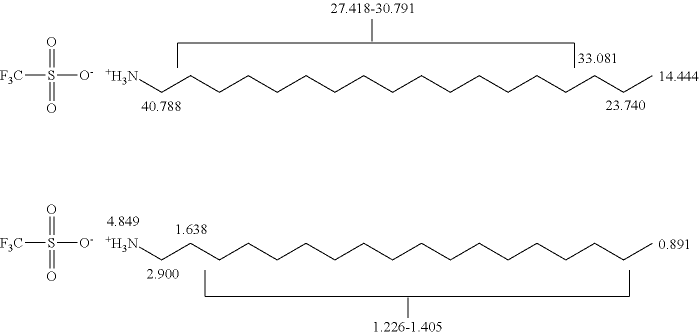

It was confirmed from the above that trifluoromethanesulfonic acid stearyl ammonium salt was obtained.

The synthesized ionic liquids are summarized in Table 19 below.

The ionic liquids synthesized in Examples 1 to 5 are referred as Ionic Liquids 1 to 5, respectively. The comparative ionic liquids synthesized in Comparative Examples 2 to 4 are referred to as Comparative Ionic Liquids 2 to 4. The melting points (endothermic peak temperatures), exothermic peak temperatures, 5% weight loss temperatures, 10% weight loss temperatures, and 20% weight loss temperatures of the ionic liquids are also depicted.

Fomblin Z-DOL was provided as Comparative Example 1. All of the ionic liquids of the present invention started the weight loss at 300° C. or higher, compared to that the weight loss of Z-DOL started from 165° C., and the decomposition exothermic temperatures of the ionic liquids of the present invention were also 400° C. or higher. Therefore, it was found that the ionic liquids of the present invention were thermally stable.

Moreover, Ionic Liquid 3 of Example 3 was compared to protic Comparative Ionic Liquid 2 (Comparative Example 2). The 5% weight loss temperatures were almost the same, but the 10% weight loss temperature and 20% weight loss temperature of Ionic Liquid 3 were higher by about 20° C. to 30° C. than those of Comparative Ionic Liquid 2, and the exothermic peak temperature of Ionic Liquid 3 was similarly high.

Moreover, Ionic Liquid 4 of Example 4 was compared to protic Comparative Ionic Liquid 3 (Comparative Example 3). The 5% weight loss temperatures were almost the same, but the 10% weight loss temperature and 20% weight loss temperature of Ionic Liquid 4 were higher by about 20° C. to 30° C. than those of Comparative Ionic Liquid 3, and the exothermic peak temperature of Ionic Liquid 4 was similarly high.

Moreover, Ionic Liquid 5 of Example 5 was compared to protic Comparative Ionic Liquid 4 (Comparative Example 4). The 5% weight loss temperature, 10% weight loss temperature, and 20% weight loss temperature of Ionic Liquid 5 were higher by about 10° C. than those of Comparative Ionic Liquid 4, and the exothermic peak temperature of Ionic Liquid 5 was similarly high.

TABLE 19

| | | pKa* of | 5% weight | 10% | 20% | | Exothermic |
|---|---|---|---|---|---|---|---|
| | | conjugate | loss | weight loss | weight loss | Endothermic | peak |
| | | base | temp./° C. | temp./° C. | temp./° C. | peak temp./° C. | temp./° C. |
| Comparative | Z-DOL | — | 165 | — | <0 | — | — |
| Ionic Liquid 1 | | | | | | | |
| (Comp. Ex. 1) | | | | | | | |
| Ionic Liquid 1 | Trifluoromethane | −12 | 315.67 | 351.83 | 384.34 | 62.3 | 403.0, |
| (Ex. 1) | sulfonic | | | | | | 464.3 |
| | acid-N-octadecyl-N′- | | | | | | |
| | methyl TBD salt | | | | | | |
| Ionic Liquid 2 | Trifluoromethane | −12 | 351.12 | 371.43 | 388.98 | 60.4 | 400.9, |
| (Ex. 2) | sulfonic | | | | | | 469.4 |
| | acid-octadecyl-N-methyl | | | | | | |
| | DBU salt | | | | | | |
| Ionic Liquid 3 | Tris(trifluoro | <−2 | 345.98 | 379.13 | 397.95 | 59.9, 97.0 | 418.4, |
| (Ex. 3) | methanesulfonyl) | | | | | | 428.7 |
| | methide | | | | | | |
| | trimethylstearyl | | | | | | |
| | ammonium salt | | | | | | |
| Comparative | Tris(trifluoro | — | 346.72 | 358.58 | 370.33 | 91.97 | 386.1, |
| Ionic Liquid 2 | methanesulfonyl) | | | | | | 397.1 |
| (Comp. Ex. 2) | methide stearyl | | | | | | |
| | ammonium salt | | | | | | |
| Ionic Liquid 4 | Hexafluorocyclo | <−2 | 327.28 | 366.88 | 391.94 | 70.3, 101.9 | 438.6 |
| (Ex. 4) | propane-1,3- | | | | | | |
| | disulfonylimide-trimethylstearyl | | | | | | |
| | ammonium salt | | | | | | |
| Comparative | Hexafluorocyclo | — | 329.6 | 347 | 365.1 | 65.7, 92.88 | 417.7 |
| Ionic Liquid 3 | propane-1,3- | | | | | | |
| (Comp. Ex. 3) | disulfonylimideoctadecyl | | | | | | |
| | ammonium | | | | | | |
| | salt | | | | | | |
| Ionic Liquid 5 | Trifluoromethane | −12 | 330.2 | 348.65 | 364.29 | 70.8, 104.7, | 383.9, |
| (Ex. 5) | sulfonic | | | | | 185.6 | 404.2 |
| | acid-trimethyl | | | | | | |
| | stearyl ammonium | | | | | | |
| | salt | | | | | | |
| Comparative | Trifluoromethane | — | 322.5 | 340.3 | 356.9 | 85.1, 122.2, | 376.9, |
| Ionic Liquid 4 | sulfonic acid | | | | | 135.6 | 389.0 |
| (Comp. Ex. 4) | stearyl ammonium | | | | | | |
| | salt | | | | | | |

*J. Phys. Org. Chem. Volume 26, Issue 2, pages 162-170, February 2013 DOI: 10.1002/poc.2946

Next, durability was studied by using a lubricant containing the ionic liquid on a magnetic recording medium.

### Example 6

The above-described magnetic disk was produced using a lubricant including TBD-C₁₈H₃₇-methyl trifluoromethane sulfonate, i.e., [Ionic Liquid 1], depicted in Table 19. As depicted in Table 20, the CSS measurement of the magnetic disk was greater than 50,000 times, and the CSS measurement of the magnetic disk after the heating test was also greater than 50,000 times. Therefore, the magnetic disk exhibited excellent durability.

### Example 7

The above-described magnetic disk was produced using a lubricant including DBU-C₁₈H₃₇-methyl trifluoromethanesulfonate, i.e., [Ionic Liquid 2], depicted in Table 19. As depicted in Table 20, the CSS measurement of the magnetic disk was greater than 50,000 times, and the CSS measurement of the magnetic disk after the heating test was also greater than 50,000 times. Therefore, the magnetic disk exhibited excellent durability.

### Example 8

The above-described magnetic disk was produced using a lubricant including tris(trifluoromethylsulfonyl)methide trimethylstearyl ammonium salt, i.e., [Ionic Liquid 3], depicted in Table 19. As depicted in Table 20, the CSS measurement of the magnetic disk was greater than 50,000 times, and the CSS measurement of the magnetic disk after the heating test was also greater than 50,000 times. Therefore, the magnetic disk exhibited excellent durability.

### Example 9

The above-described magnetic disk was produced using a lubricant including hexafluorocyclopropylbissulfoimide trimethylstearyl ammonium salt, i.e., [Ionic Liquid 4], depicted in Table 19. As depicted in Table 20, the CSS measurement of the magnetic disk was greater than 50,000 times, and the CSS measurement of the magnetic disk after the heating test was also greater than 50,000 times. Therefore, the magnetic disk exhibited excellent durability.

### Example 10

The above-described magnetic disk was produced using a lubricant including trifluoromethanesulfonic acid-trimethylstearyl ammonium salt, i.e., [Ionic Liquid 5], depicted in Table 19. As depicted in Table 20, the CSS measurement of the magnetic disk was greater than 50,000 times, and the CSS measurement of the magnetic disk after the heating test was also greater than 50,000 times. Therefore, the magnetic disk exhibited excellent durability.

### Comparative Example 5

The above-described magnetic disk was produced using a lubricant including Z-DOL of [Comparative Example 1], depicted in Table 19. As depicted in Table 20, the durability of the magnetic disk measured by the CSS measurement was greater than 50,000 times, but the CSS measurement of the magnetic disk after the heating test was 12,000 times. It was assumed that durability of the magnetic disk after heating was deteriorated because deterioration of the lubricant by the heat was large.

TABLE 20

| | CSS durability | | CSS durability after heating | |
|---|---|---|---|---|
| Ex. 6 | 25° C., 60% RH | >50,000 | 25° C., 60% RH | >50,000 |
| Ex. 7 | 25° C., 60% RH | >50,000 | 25° C., 60% RH | >50,000 |
| Ex. 8 | 25° C., 60% RH | >50,000 | 25° C., 60% RH | >50,000 |
| Ex. 9 | 25° C., 60% RH | >50,000 | 25° C., 60% RH | >50,000 |
| Ex. 10 | 25° C., 60% RH | >50,000 | 25° C., 60% RH | >50,000 |
| Comp. | 25° C., 60% RH | >50,000 | 25° C., 60% RH | 12,000 |
| Ex. 5 | | | | |

As was clear from the explanations above, the lubricant of the present invention including the aprotic ionic liquid of the present invention could maintain excellent lubricity even under high temperature storage conditions, and CSS lubricity of the lubricant could be maintained over a long period.

Next, examples where Ionic Liquids 1 to 5 and Comparative Ionic Liquid 1 are applied for magnetic tapes are described.

### Example 11

The above-described magnetic tape was produced using a lubricant including Ionic Liquid 1. As depicted in Table 21, a coefficient of friction of the magnetic tape after 100 times of the shuttle running was 0.23 in the environment having a temperature of −5° C., and 0.25 in the environment having a temperature of 40° C. and relative humidity of 90%. Moreover, the still durability test was greater than 60 min in the environment having a temperature of −5° C., and greater than 60 min in the environment having a temperature of 40° C. and relative humidity of 30%. Moreover, the shuttle durability test was greater than 200 times in the environment having a temperature of −5° C., and greater than 200 times in the environment having a temperature of 40° C. and relative humidity of 90%. Moreover, the still durability test after the heating test was greater than 60 min in the environment having a temperature of −5° C., and greater than 60 min in the environment having a temperature of 40° C. and relative humidity of 30%. Moreover, the shuttle durability test after the heating test was greater than 200 times in the environment having a temperature of −5° C., and greater than 200 times in the environment having a temperature of 40° C. and relative humidity of 90%. It was found from the results above that the magnetic tape, to which Ionic Liquid 1 had been applied, had excellent abrasion properties, still durability, and shuttle durability.

### Example 12

The above-described magnetic tape was produced using a lubricant including Ionic Liquid 2. As depicted in Table 21, a coefficient of friction of the magnetic tape after 100 times of the shuttle running was 0.23 in the environment having a temperature of −5° C., and 0.26 in the environment having a temperature of 40° C. and relative humidity of 90%. Moreover, the still durability test was greater than 60 min in the environment having a temperature of −5° C., and greater than 60 min in the environment having a temperature of 40° C. and relative humidity of 30%. Moreover, the shuttle durability test was greater than 200 times in the environment having a temperature of −5° C., and greater than 200 times in the environment having a temperature of 40° C. and relative humidity of 90%. Moreover, the still durability test after the heating test was greater than 60 min in the environment having a temperature of −5° C., and greater than 60 min in the environment having a temperature of 40° C. and relative humidity of 30%. Moreover, the shuttle durability test after the heating test was greater than 200 times in the environment having a temperature of −5° C., and greater than 200 times in the environment having a temperature of 40° C. and relative humidity of 90%. It was found from the results above that the magnetic tape, to which Ionic Liquid 2 had been applied, had excellent abrasion properties, still durability, and shuttle durability.

### Example 13

The above-described magnetic tape was produced using a lubricant including Ionic Liquid 3. As depicted in Table 21, a coefficient of friction of the magnetic tape after 100 times of the shuttle running was 0.19 in the environment having a temperature of −5° C., and 0.23 in the environment having a temperature of 40° C. and relative humidity of 90%. Moreover, the still durability test was greater than 60 min in the environment having a temperature of −5° C., and greater than 60 min in the environment having a temperature of 40° C. and relative humidity of 30%. Moreover, the shuttle durability test was greater than 200 times in the environment having a temperature of −5° C., and greater than 200 times in the environment having a temperature of 40° C. and relative humidity of 90%. Moreover, the still durability test after the heating test was greater than 60 min in the environment having a temperature of −5° C., and greater than 60 min in the environment having a temperature of 40° C. and relative humidity of 30%. Moreover, the shuttle durability test after the heating test was greater than 200 times in the environment having a temperature of −5° C., and greater than 200 times in the environment having a temperature of 40° C. and relative humidity of 90%. It was found from the results above that the magnetic tape, to which Ionic Liquid 3 had been applied, had excellent abrasion properties, still durability, and shuttle durability.

### Example 14

The above-described magnetic tape was produced using a lubricant including Ionic Liquid 4. As depicted in Table 21, a coefficient of friction of the magnetic tape after 100 times of the shuttle running was 0.20 in the environment having a temperature of −5° C., and 0.23 in the environment having a temperature of 40° C. and relative humidity of 90%. Moreover, the still durability test was greater than 60 min in the environment having a temperature of −5° C., and greater than 60 min in the environment having a temperature of 40° C. and relative humidity of 30%. Moreover, the shuttle durability test was greater than 200 times in the environment having a temperature of −5° C., and greater than 200 times in the environment having a temperature of 40° C. and relative humidity of 90%. Moreover, the still durability test after the heating test was greater than 60 min in the environment having a temperature of −5° C., and greater than 60 min in the environment having a temperature of 40° C. and relative humidity of 30%. Moreover, the shuttle durability test after the heating test was greater than 200 times in the environment having a temperature of −5° C., and greater than 200 times in the environment having a temperature of 40° C. and relative humidity of 90%. It was found from the results above that the magnetic tape, to which Ionic Liquid 4 had been applied, had excellent abrasion properties, still durability, and shuttle durability.

### Example 15

The above-described magnetic tape was produced using a lubricant including Ionic Liquid 5. As depicted in Table 21, a coefficient of friction of the magnetic tape after 100 times of the shuttle running was 0.21 in the environment having a temperature of −5° C., and 0.24 in the environment having a temperature of 40° C. and relative humidity of 90%. Moreover, the still durability test was greater than 60 min in the environment having a temperature of −5° C., and greater than 60 min in the environment having a temperature of 40° C. and relative humidity of 30%. Moreover, the shuttle durability test was greater than 200 times in the environment having a temperature of −5° C., and greater than 200 times in the environment having a temperature of 40° C. and relative humidity of 90%. Moreover, the still durability test after the heating test was greater than 60 min in the environment having a temperature of −5° C., and greater than 60 min in the environment having a temperature of 40° C. and relative humidity of 30%. Moreover, the shuttle durability test after the heating test was greater than 200 times in the environment having a temperature of −5° C., and greater than 200 times in the environment having a temperature of 40° C. and relative humidity of 90%. It was found from the results above that the magnetic tape, to which Ionic Liquid 5 had been applied, had excellent abrasion properties, still durability, and shuttle durability.

### Comparative Example 6

The above-described magnetic tape was produced using a lubricant including Comparative Ionic Liquid 1. As depicted in Table 21, a coefficient of friction of the magnetic tape after 100 times of the shuttle running was 0.25 in the environment having a temperature of −5° C., and 0.30 in the environment having a temperature of 40° C. and relative humidity of 90%. Moreover, the still durability test was 12 min in the environment having a temperature of −5° C., and 48 min in the environment having a temperature of 40° C. and relative humidity of 30%. Moreover, the shuttle durability test was 59 times in the environment having a temperature of −5° C., and 124 times in the environment having a temperature of 40° C. and relative humidity of 90%. Moreover, the still durability test after the heating test was 12 min in the environment having a temperature of −5° C., and 15 min in the environment having a temperature of 40° C. and relative humidity of 30%. Moreover, the shuttle durability test after the heating test was 46 times in the environment having a temperature of −5° C., and 58 times in the environment having a temperature of 40° C. and relative humidity of 90%. It was found from the results above that the magnetic tape, to which Comparative Ionic Liquid 1 had been applied, had significant deterioration in still durability and shuttle durability after the heating test.

TABLE 21

| | Coefficient of | | | | Shuttle | | Still durability | | Shuttle durability | |
|---|---|---|---|---|---|---|---|---|---|---|
| | friction after | | Still durability/ | | durability/ | | after heating/ | | after heating/ | |
| | 100 running | | min | | times | | min | | times | |
| Ex. 11 | −5° C. | 0.23 | −5° C. | >60 | −5° C. | >200 | −5° C. | >60 | −5° C. | >200 |
| | 40° C., | 0.25 | 40° C., | >60 | 40° C., | >200 | 40° C., | >60 | 40° C., | >200 |
| | 90% RH | | 30% RH | | 90% RH | | 30% RH | | 90% RH | |
| Ex. 12 | −5° C. | 0.23 | −5° C. | >60 | −5° C. | >200 | −5° C. | >60 | −5° C. | >200 |
| | 40° C., | 0.26 | 40° C., | >60 | 40° C., | >200 | 40° C., | >60 | 40° C., | >200 |
| | 90% RH | | 30% RH | | 90% RH | | 30% RH | | 90% RH | |
| Ex. 13 | −5° C. | 0.19 | −5° C. | >60 | −5° C. | >200 | −5° C. | >60 | −5° C. | >200 |
| | 40° C., | 0.23 | 40° C., | >60 | 40° C., | >200 | 40° C., | >60 | 40° C., | >200 |
| | 90% RH | | 30% RH | | 90% RH | | 30% RH | | 90% RH | |
| Ex. 14 | −5° C. | 0.20 | −5° C. | >60 | −5° C. | >200 | −5° C. | >60 | −5° C. | >200 |
| | 40° C., | 0.23 | 40° C., | >60 | 40° C., | >200 | 40° C., | >60 | 40° C., | >200 |
| | 90% RH | | 30% RH | | 90% RH | | 30% RH | | 90% RH | |
| Ex. 15 | −5° C. | 0.21 | −5° C. | >60 | −5° C. | >60 | −5° C. | >60 | −5° C. | >200 |
| | 40° C., | 0.24 | 40° C., | >60 | 40° C., | >60 | 40° C., | >60 | 40° C., | >200 |
| | 90% RH | | 30% RH | | 90% RH | | 30% RH | | 90% RH | |
| Comp. | −5° C. | 0.25 | −5° C. | 12 | −5° C. | 59 | −5° C. | 12 | −5° C. | 46 |
| Ex. 6 | 40° C., | 0.30 | 40° C., | 48 | 40° C., | 124 | 40° C., | 15 | 40° C., | 58 |
| | 90% RH | | 30% RH | | 90% RH | | 30% RH | | 90% RH | |

It was also evident from the results above that the magnetic tape, to which the lubricant of the present invention including the aprotic ionic liquid of the present invention had been applied, exhibited excellent abrasion resistance, still durability, and shuttle durability. In case of Z-DOL as Comparative Example, however, deterioration in the durability was significant similarly to the case of the above-described disk.

As is clear from the explanations above, the lubricant including an ionic liquid, which contains a conjugate acid (B⁺) and a conjugate base (X⁻) and is aprotic, wherein the conjugate acid contains a straight-chain hydrocarbon group having 10 or more carbon atoms, and wherein an acid that is a source of the conjugate base has a pKa in water of 0 or less, can maintain lubricity even under high temperature conditions, and can maintain lubricity over a long period. Accordingly, a magnetic recording medium using the lubricant containing the ionic liquid achieves extremely excellent running performances, abrasion resistance, and durability.

### REFERENCE SIGNS LIST

11 substrate
12 base layer
13 magnetic layer
14 protective carbon layer
15 lubricant layer
21 substrate
22 magnetic layer
23 protective carbon layer
24 lubricant layer
25 back-coating layer

1. A lubricant comprising:
an ionic liquid, which contains a conjugate acid (B⁺) and a conjugate base (X⁻), and is aprotic,
wherein the conjugate acid contains a straight-chain hydrocarbon group having 10 or more carbon atoms, and
wherein an acid that is a source of the conjugate base has a pKa in water of 0 or less.

2. The lubricant according to claim 1,
wherein the conjugate acid is generated from a base containing a straight-chain hydrocarbon group having 10 or more carbon atoms, and the base is amine, amidine, guanidine, or imidazole.

3. The lubricant according to claim 1,
wherein the ionic liquid is represented by one of the following general formulae (1) to (3): 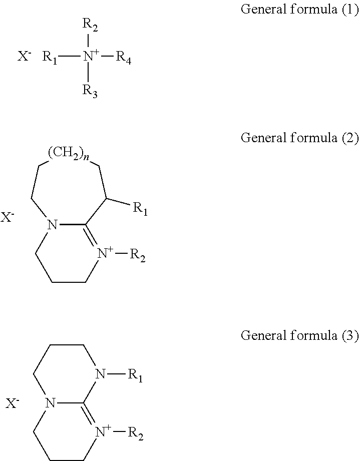
where R₁, R₂, R₃, and R₄ are groups other than hydrogen atoms, and at least one of R₁, R₂, R₃, and R₄ is a group containing a straight-chain hydrocarbon group having 10 or more carbon atoms in the general formula (1),
where R₁ is a group containing a straight-chain hydrocarbon group having 10 or more carbon atoms, R₂ is a group other than a hydrogen atom, and n is 0 or 1 in the general formula (2), and
where R₁ is a group containing a straight-chain hydrocarbon group having 10 or more carbon atoms, and R₂ is a group other than a hydrogen atom in the general formula (3).

4. The lubricant according to claim 1,
wherein the conjugate base is represented by the following general formula (4): 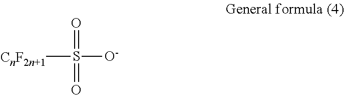
where n is an integer of 0 or greater in the general formula (4).

5. The lubricant according to claim 1,
wherein the conjugate base is represented by one of the following structural formulae (1) to (4):

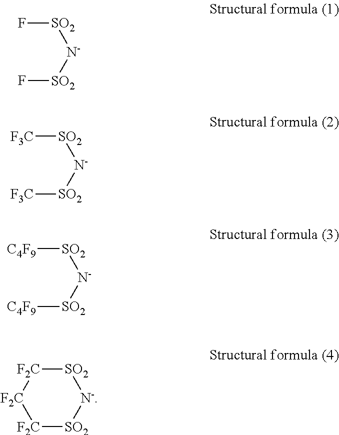

6. The lubricant according to claim 1,
wherein the conjugate base is represented by the following general formula (5): 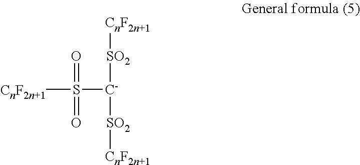
where n is an integer of 1 or greater in the general formula (5).

7. The lubricant according to claim 1,
wherein the hydrocarbon group is an alkyl group.

8. A magnetic recording medium comprising:
a non-magnetic support;
a magnetic layer on the non-magnetic support; and
the lubricant according to claim 1 on the magnetic layer.

9. An ionic liquid comprising:
a conjugate acid (B⁺); and
a conjugate base (X⁻),
wherein the conjugate acid contains a straight-chain hydrocarbon group having 10 or more carbon atoms,
wherein an acid that is a source of the conjugate base has a pKa in water of 0 or less, and
wherein the ionic liquid is aprotic.

10. The ionic liquid according to claim 9,
wherein the conjugate acid is generated from a base containing a straight-chain hydrocarbon group having 10 or more carbon atoms, and the base is amine, amidine, guanidine, or imidazole.

11. The ionic liquid according to claim 9,
wherein the ionic liquid is represented by one of the following general formulae (1) to (3): 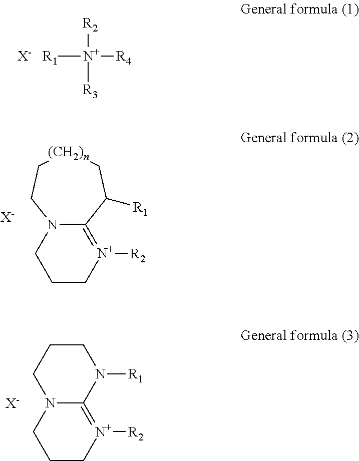
where R₁, R₂, R₃, and R₄ are groups other than hydrogen atoms, and at least one of R₁, R₂, R₃, and R₄ is a group containing a straight-chain hydrocarbon group having 10 or more carbon atoms in the general formula (1),
where R₁ is a group containing a straight-chain hydrocarbon group having 10 or more carbon atoms, R₂ is a group other than a hydrogen atom, and n is 0 or 1 in the general formula (2), and
where R₁ is a group containing a straight-chain hydrocarbon group having 10 or more carbon atoms, and R₂ is a group other than a hydrogen atom in the general formula (3).

12. The ionic liquid according to claim 9,
wherein the conjugate base is represented by the following general formula (4): 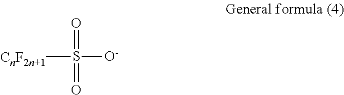
where n is an integer of 0 or greater in the general formula (4).

13. The ionic liquid according to claim 9,
wherein the conjugate base is represented by one of the following structural formulae (1) to (4):

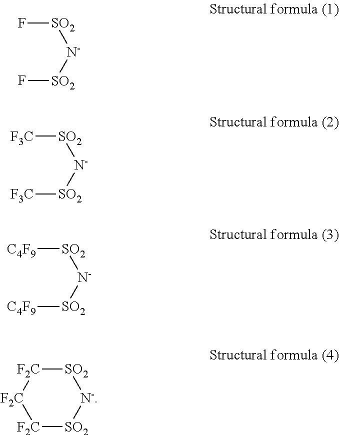

14. The ionic liquid according to claim 9,
wherein the conjugate base is represented by the following general formula (5): 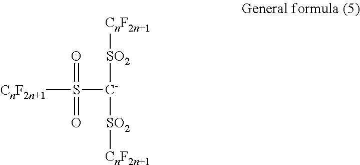
where n is an integer of 1 or greater in the general formula (5).

15. The ionic liquid according to claim 9,
wherein the hydrocarbon group is an alkyl group.
